(19) United States
(12) Patent Application Publication
(10) Pub. No.: US 2024/0320322 A1
(43) Pub. Date: Sep. 26, 2024

(54) CIRCUITRY AND METHODS FOR IMPLEMENTING A TRUSTED EXECUTION ENVIRONMENT SECURITY MANAGER

(71) Applicant: Intel Corporation, Santa Clara, CA (US)

(72) Inventors: Jiewen Yao, Shanghai (CN); Vedvyas Shanbhogue, Austin, TX (US); Ravi Sahita, Portland, OR (US)

(21) Appl. No.: 18/575,836

(22) PCT Filed: Dec. 20, 2021
(86) PCT No.: PCT/CN2021/139531

§ 371 Date: Dec. 30, 2023

(51) Int. Cl. G06F 21/53; G06F 21/64

(52) U.S. Cl. CPC G06F 21/53; G06F 21/64

(57) ABSTRACT

Systems, methods, and apparatuses for implementing a trusted execution environment security manager are described. In one example, hardware processor includes a hardware processor core comprising a trust domain manager to manage one or more hardware isolated virtual machines as a respective trust domain, a coupling between the hardware processor core and an input/output device, and a secure startup service circuit separate from the trust domain manager to, in response to a request from the trust domain manager, generate a secure communication session between the trust domain manager and the input/output device.

### TECHNICAL FIELD

The disclosure relates generally to electronics, and, more specifically, an example of the disclosure relates to circuitry for implementing a trusted execution environment security manager.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a block diagram of a computer system including a plurality of cores having a trust domain manager, a memory, an input/output device, and a secure startup service circuit according to examples of the disclosure.

FIG. 2 illustrates a block diagram of a host coupled to a device according to examples of the disclosure.

FIG. 3 is a swim lane diagram of a secure communication session initialization flow of a virtual machine manager (VMM), trusted execution environment security manager (TSM) comprising a trust domain manager (TDM) and a secure startup service circuit (S3C), and a device according to examples of the disclosure.

FIG. 4 is a swim lane diagram of a secure communication session initialization flow of a virtual machine manager (VMM), trusted execution environment security manager (TSM) comprising a trust domain manager (TDM) and a secure startup service circuit (S3C), and a device wherein the VMM communicates with the S3C directly according to examples of the disclosure.

FIG. 5 is a flow diagram illustrating operations of a method of generating a secure communication session according to examples of the disclosure.

FIG. 6 illustrates a hardware processor coupled to storage that includes one or more job enqueue instructions according to examples of the disclosure.

FIG. 7 is a flow diagram illustrating operations of a method for processing a job enqueue instruction according to examples of the disclosure.

FIG. 8A is a block diagram illustrating a generic vector friendly instruction format and class A instruction templates thereof according to examples of the disclosure.

FIG. 8B is a block diagram illustrating the generic vector friendly instruction format and class B instruction templates thereof according to examples of the disclosure.

FIG. 9A is a block diagram illustrating fields for the generic vector friendly instruction formats in FIGS. 8A and 8B according to examples of the disclosure.

FIG. 9B is a block diagram illustrating the fields of the specific vector friendly instruction format in FIG. 9A that make up a full opcode field according to one example of the disclosure.

FIG. 9C is a block diagram illustrating the fields of the specific vector friendly instruction format in FIG. 9A that make up a register index field according to one example of the disclosure.

FIG. 9D is a block diagram illustrating the fields of the specific vector friendly instruction format in FIG. 9A that make up the augmentation operation field 850 according to one example of the disclosure.

FIG. 10 is a block diagram of a register architecture according to one example of the disclosure

FIG. 11A is a block diagram illustrating both an exemplary in-order pipeline and an exemplary register renaming, out-of-order issue/execution pipeline according to examples of the disclosure.

FIG. 11B is a block diagram illustrating both an exemplary example of an in-order architecture core and an exemplary register renaming, out-of-order issue/execution architecture core to be included in a processor according to examples of the disclosure.

FIG. 12A is a block diagram of a single processor core, along with its connection to the on-die interconnect network and with its local subset of the Level 2 (L2) cache, according to examples of the disclosure.

FIG. 12B is an expanded view of part of the processor core in FIG. 12A according to examples of the disclosure.

FIG. 13 is a block diagram of a processor that may have more than one core, may have an integrated memory controller, and may have integrated graphics according to examples of the disclosure.

FIG. 14 is a block diagram of a system in accordance with one example of the present disclosure.

FIG. 15 is a block diagram of a more specific exemplary system in accordance with an example of the present disclosure.

FIG. 16, shown is a block diagram of a second more specific exemplary system in accordance with an example of the present disclosure.

FIG. 17, shown is a block diagram of a system on a chip (SoC) in accordance with an example of the present disclosure.

FIG. 18 is a block diagram contrasting the use of a software instruction converter to convert binary instructions in a source instruction set to binary instructions in a target instruction set according to examples of the disclosure.

### DETAILED DESCRIPTION

In the following description, numerous specific details are set forth. However, it is understood that examples of the disclosure may be practiced without these specific details. In other instances, well-known circuits, structures, and techniques have not been shown in detail in order not to obscure the understanding of this description.

References in the specification to “one example,” “an example,” “examples,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Certain operations include accessing one or more memory locations, e.g., to store and/or read (e.g., load) data. A system may include a plurality of cores, e.g., with a proper subset of cores in each socket of a plurality of sockets, e.g., of a system-on-a-chip (SoC). Each core (e.g., each processor or each socket) may access data storage (e.g., a memory). Memory may include volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM) (e.g., an Intel® Optane™ memory), for example, accessible according to a Peripheral Component Interconnect Express (PCIe) standard.

In certain examples of computing, a virtual machine (VM) (e.g., guest) is an emulation of a computer system. In certain examples, VMs are based on a specific computer architecture and provide the functionality of an underlying physical computer system. Their implementations may involve specialized hardware, firmware, software, or a combination. In certain examples, a virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage, and other input/output (I/O) resources, such as, but not limited to, an input/output memory management unit (IOMMU). The VMM may provide a centralized interface for managing the entire operation, status, and availability of VMs that are installed over a single host machine or spread across different and interconnected hosts.

However, it may be desirable to maintain the security (e.g., confidentiality) of information for a virtual machine from the VMM and/or other virtual machine(s). Certain processors (e.g., a system-on-a-chip (SoC) including a processor) utilize their hardware to isolate virtual machines, for example, with each referred to as a “trust domain”. Certain processors support an instruction set architecture (ISA) (e.g., ISA extension) to implement trust domains. For example, Intel® trust domain extensions (Intel® TDX) that utilize architectural elements to deploy hardware-isolated virtual machines (VMs) referred to as trust domains (TDs).

In certain examples, a hardware processor and its ISA (e.g., a trust domain manager thereof) isolates TD VMs from the VMM (e.g., hypervisor) and/or other non-TD software (e.g., on the host platform). In certain examples, a hardware processor and its ISA (e.g., a trust domain manager thereof) implement trust domains to enhance confidential computing by helping protect the trust domains from a broad range of software attacks and reducing the td trusted computing base (TCB). In certain examples, a hardware processor and its ISA (e.g., a trust domain manager thereof) enhances a cloud tenant's control of data security and protection. In certain examples, a hardware processor and its ISA (e.g., a trust domain manager thereof) implement trust domains (e.g., trusted virtual machines) to enhance a cloud-service provider's (CSP) ability to provide managed cloud services without exposing tenant data to adversaries.

In certain examples, a hardware processor and its ISA (e.g., a trust domain manager thereof) also support device input/output (I/O). For example, with an ISA (e.g., Intel® TDX 2.0) supporting trust domain extension (TDX) with device Input/Output (I-O) (e.g., TDX-IO). In certain examples, a hardware processor and its ISA (e.g., a trust domain manager thereof) that support device input/output (I/O) (e.g., TDX-IO) enables the use (e.g., assignment) of a virtual function (VF) and/or virtual interface (VF) of a device to (e.g., only) a specific TD.

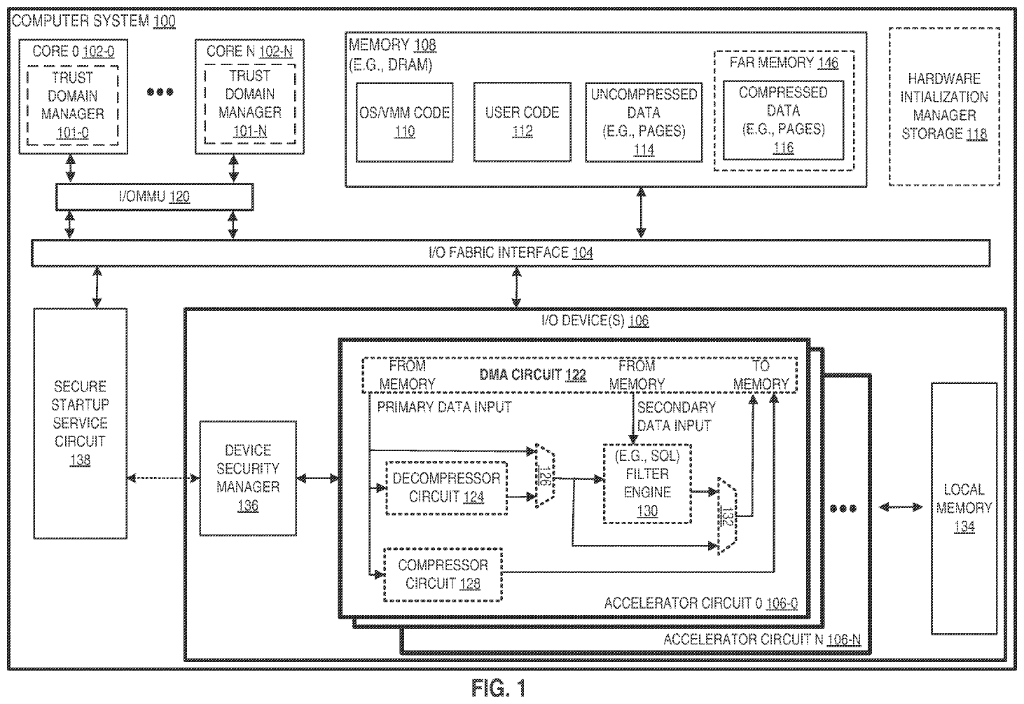

In certain examples, an I/O device is an accelerator. One or more types of accelerators may be utilized. For example, a first type of accelerator may be accelerator circuit 106-0 from FIG. 1, e.g., an In-Memory Analytics accelerator (IAX). A second type of accelerator supports a set of transformation operations on memory, e.g., a data streaming accelerator (DSA). For example, to generate and test cyclic redundancy check (CRC) checksum or Data Integrity Field (DIF) to support storage and networking applications and/or for memory compare and delta generate/merge to support VM migration, VM Fast check-pointing, and software managed memory deduplication usages. A third type of accelerator supports security, authentication, and compression operations (e.g., cryptographic acceleration and compression operations), e.g., a QuickAssist Technology (QAT) accelerator.

In order to establish the trust relationship between a device and a TD, certain TDX-IO architectures require the TD and/or a trust domain manager (e.g., circuit and/or code) (e.g., Trusted Execution Environment (TEE) security manager (TSM)) to create a secure communication session between the device and the trust domain manger (e.g., for the trust domain manger to allow a particular trust domain to use the device or a subset of function(s) of the device). In order to establish the trust relationship between a device and a TD, certain TDX-IO architectures require the TD and/or a trust domain manager (e.g., circuit and/or code) (e.g., Trusted Execution Environment (TEE) security manager (TSM)) use (i) a Distributed Management Task Force (DMTF) Secure Protocol and Data Model (SPDM) standard to authenticate the device (e.g., and collect device measurement), and (ii) use a Peripheral Component Interconnect Special Interest Group (PCI-SIG) Device Interface Management Protocol (DIMP) standard (e.g., to communicate with a device security manager (DSM) to manage the device's virtual function(s)).

In certain examples, a SPDM messaging protocol defines a request-response messaging model between two endpoints to perform the message exchanges outlined in SPDM message exchanges, for example, where each SPDM request message shall be responded to with an SPDM response message as defined in the SPDM specification. In certain examples, an endpoint's (e.g., device's) “measurement” describes the process of calculating the cryptographic hash value of a piece of firmware/software or configuration data and tying the cryptographic hash value with the endpoint identity through the use of digital signatures. This allows an authentication initiator to establish that the identity and measurement of the firmware/software or configuration running on the endpoint.

In certain examples, to help enforce the security policies for the TDs, a new mode of a processor called Secure-Arbitration Mode (SEAM) is introduced to host an (e.g., manufacturer provided) digitally signed, but not encrypted, security-services module. In certain examples, a trust domain manager (TDM) 206 is hosted in a reserved, memory space identified by a SEAM-range register (SEAMRR). In certain examples, the processor only allows access to SEAM-memory range to software executing inside the SEAM-memory range, and all other software accesses and direct-memory access (DMA) from devices to this memory range are aborted. In certain examples, a SEAM module does not have any memory-access privileges to other protected, memory regions in the platform, including the System-Management Mode (SMM) memory or (e.g., Intel® Software Guard Extensions (SGX)) protected memory.

Certain standards (e.g., DIMP standard) introduces a trusted execution environment (TEE) security manager (TSM) concept, but do not describe how to implement the TSM in a confidential computing environment, e.g., an environment implementing TDX-IO. In certain examples, one place to support a TSM is a trust domain manager of a processor (e.g., in a trust domain manager (TDM) 206 or SEAM module), because it is independent of the other TDs and it can enforce the desired isolation.

However, in certain examples, implementing a TSM in a trust domain manager of a processor will bring performance and long latency issues in certain (e.g., SPDM) communications. One solution is for the trust domain manager to delegate (e.g., SPDM) implementation work to a standalone service TD (e.g., TDX-IO Provisioning Agent (TPA)), e.g., such that the service TD is a generic solution for the TSM. However, in certain examples, it is a burden to maintain the trust relationship between the trust domain manager (e.g., trust domain manager (TDM) 206) and a service TD, for example, if the trust domain manager of the processor includes the TPA-TD “measurement”, then any TPA-TD update will trigger a trust domain manager (e.g., trust domain manager (TDM) 206) update. For example, where using a service-TD based TSM adds a management burden to the VMM and the trust domain manager (e.g., trust domain manager (TDM) 206), e.g., where the VMM is to be aware of the existence of TPA-TD and handle it specially to support device interface assignment for TD and the trust domain manager (e.g., trust domain manager (TDM) 206) is verify the integrity of TPA-TD during TD launch and distinguish the request from a TPA-TD or a “normal” TD.

In certain examples, the trust domain manager stalls other work while waiting for the generation of a secure communication session (e.g., between a device and the trust domain manager). Examples herein are improvements to the functioning of a SoC (e.g., processor) (e.g., of a computer) itself as they resolve the above issues by mitigating the performance and long latency issues for the trust domain manager and/or removing the stall by allowing the (e.g., SPDM) communication work (e.g., to establish a secure communication session) to be performed by a secure startup service circuit (S3C) of the SoC (e.g., processor) (e.g., secure startup service module (S3M)). In certain examples, a secure startup service circuit includes SPDM capability and stack/device attestation capability, e.g., to support TDX-IO uses and other (e.g., non TDX-IO) uses.

Examples herein jointly utilize a trust domain manager and a secure startup service circuit to implement a TEE security manager to setup a secure connection with the device. Examples herein allow a trust domain manager of a processor to delegate the (e.g., SPDM) secure communication session establishment work, e.g., to a SOC coprocessor or microcontroller (e.g., Secure Startup Service Module (S3M) circuit). In certain examples, the trust domain manager of a processor and secure startup service circuit (S3C) (e.g., separate from the trust domain manager) are combined to provide the functionality of a full TEE security manager (TSM). In certain examples, a whole TSM includes two parts: (i) the trust domain manager enforces the TEE isolation, and (ii) the S3C handles communications with the device security manager (DSM).

It should be understood that the functionality herein may be added to other confidential computing technology as a computing solution for I/O devices. For example, AMD® Secure Encrypted Virtualization (e.g., SEV/SEV-ES/SEV-SNP) may desire to use a certain component (e.g., a Platform Security Processor (PSP)) thereof to implement a TSM, for example, a whole TSM including two parts: (i) a trust domain manager that enforces the TEE isolation, and (ii) the PSP that handles communications with the device security manager (DSM). For example, ARM® Realm Management Extension (RME) may desire to use a certain component (e.g., one ARM® core of a plurality of ARM® cores) thereof to implement a TSM, for example, a whole TSM including two parts: (i) a trust domain manager that enforces the TEE isolation, and (ii) the ARM® core that handles communications with the device security manager (DSM).

Turning now to FIG. 1, an example system architecture is depicted. FIG. 1 illustrates a block diagram of a computer system 100 including a plurality of cores 102-0 to 102-N (e.g., where N is any positive integer greater than one, although single core examples may also be utilized) having a trust domain manager 101-0 to 101-N, a memory 108, an input/output device 106, and a secure startup service circuit 138 according to examples of the disclosure.

In certain examples, I/O device 106 includes one or more accelerators (e.g., accelerator circuits 106-0 to 106-N (e.g., where N is any positive integer greater than one, although single accelerator circuit examples may also be utilized)).

Although the example shown in FIG. 1 of the device 106 is an accelerator, it should be understood that other devices (e.g., non-accelerator devices) can utilized the examples disclosed herein. In the depicted example, a (e.g., each) accelerator circuit 106-0 to 106-N includes a decompressor circuit 124 to perform decompression operations, a compressor circuit 128 to perform compression operations, and a direct memory access (DMA) circuit 122, e.g., to connect to memory 108, internal memory (e.g., cache) of a core, and/or far memory 146. In one example, compressor circuit 128 is (e.g., dynamically) shared by two or more of the accelerator circuits 106-0 to 106-N. In certain examples, the data for a job that is assigned to a particular accelerator circuit (e.g., accelerator circuit 106-0) is streamed in by DMA circuit 122, for example, as primary and/or secondary input.

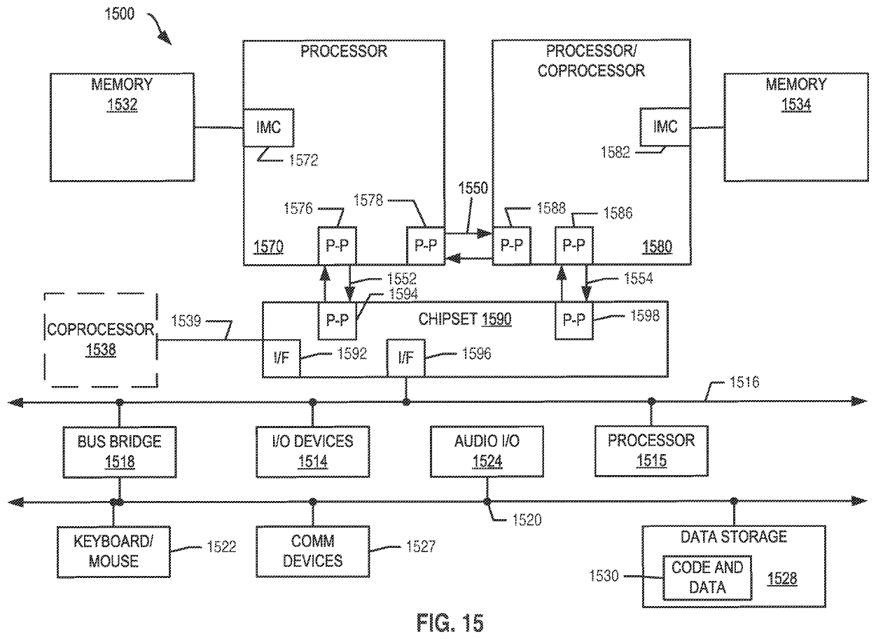

Multiplexers 126 and 132 may be utilized to route data for a particular operation. Optionally, a (e.g., Structured Query Language (SQL)) filter engine 130 may be included, for example, to perform a filtering query (e.g., for a search term input on the secondary data input) on input data, e.g., on decompressed data output from decompressor circuit 124. Device 106 may include a local memory 134, e.g., shared by a plurality of accelerator circuits 106-0 to 106-N. Computer system 100 may couple to a hard drive, e.g., storage unit 1528 in FIG. 15.

Memory 108 may include operating system (OS) and/or virtual machine monitor code 110, user (e.g., program) code 112, uncompressed data (e.g., pages) 114, compressed data (e.g., pages) 116 or any combination thereof. In certain examples of computing, a virtual machine (VM) is an emulation of a computer system. In certain examples, VMs are based on a specific computer architecture and provide the functionality of an underlying physical computer system. Their implementations may involve specialized hardware, firmware, software, or a combination. In certain examples, the virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage, and other input/output (I/O) resources, such as, but not limited to, an input/output memory management unit (IOMMU). The VMM may provide a centralized interface for managing the entire operation, status, and availability of VMs that are installed over a single host machine or spread across different and interconnected hosts.

Memory 108 may be memory separate from a core and/or device 106. Memory 108 may be DRAM. Compressed data 116 may be stored in a first memory device (e.g., far memory 146) and/or uncompressed data 114 may be stored in a separate, second memory device (e.g., as near memory).

A coupling (e.g., input/output (I/O) fabric interface 104) may be included to allow communication between device 106, core(s) 102-0 to 102-N, memory 108, etc.

In certain examples, the hardware initialization manager (non-transitory) storage 118 stores hardware initialization manager firmware (e.g., or software). In one example, the hardware initialization manager (non-transitory) storage 118 stores Basic Input/Output System (BIOS) firmware. In another example, the hardware initialization manager (non-transitory) storage 118 stores Unified Extensible Firmware Interface (UEFI) firmware. In certain examples (e.g., triggered by the power-on or reboot of a processor), computer system 100 (e.g., core 102-0) executes the hardware initialization manager firmware (e.g., or software) stored in hardware initialization manager (non-transitory) storage 118 to initialize the system 100 for operation, for example, to begin executing an operating system (OS) and/or initialize and test the (e.g., hardware) components of system 100.

In certain examples, computer system 100 includes an input/output memory management unit (I/OMMU) 120, e.g., coupled between one or more cores 102-0 to 102-N and I/O fabric interface 104. In certain examples, I/OMMU 120 provides address translation, for example, from a virtual address to a physical address. In certain examples, a device 106 has a mode for support of shared virtual memory, whereby virtual addresses are specified in a descriptor, and the hardware translates these into physical addresses using address translation services of the I/OMMU 120.

A device 106 may include any of the depicted components. For example, with one or more instances of an accelerator circuit 106-0 to 106-N. In certain examples, a job (e.g., corresponding descriptor for that job) is submitted to the device 106 and the device to performs one or more (e.g., decompression or compression) operations. In certain examples, device 106 includes a local memory 134. In certain examples, device 106 is a TEE I/O capable device, for example, with the host (e.g., processor including one of more of cores 102-0 to 102-N) being a TEE capable host. In certain examples, a TEE capable host implements a TEE security manager.

In certain examples, a trusted execution environment (TEE) security manager (e.g., jointly implemented by a trust domain manager 101 and a secure startup service circuit 138) is to: provide interfaces to the VMM to assign memory, processor, and other resources to trust domains (e.g., trusted virtual machines), (ii) implements the security mechanisms and access controls (e.g., IOMMU translation tables, etc.) to protect confidentiality and integrity of the trust domains (e.g., trusted virtual machines) data and execution state in the host from entities not in the trusted computing base of the trust domains (e.g., trusted virtual machines), (iii) uses a protocol to manage the security state of the trusted device interface (TDI) to be used by the trust domains (e.g., trusted virtual machines), (iv) establishing/managing IDE encryption keys for the host, and, if needed, scheduling key refreshes. TSM programs the IDE encryption keys into the host root ports and communicates with the DSM to configure integrity and data encryption IDE) encryption keys in the device, (v) or any single or combination thereof.

In certain examples, a device security manager (DSM) 136 is to (i) authenticate of device identities and measurement reporting, (ii) configuring the IDE encryption keys in the device (e.g., where the TSM provide the keys for the initial configuration and subsequent key refreshes to the DSM), (iii) provide device interface management for locking TDI configuration, reporting TDI configurations, attaching, and detaching TDIs to trust domains (e.g., trusted virtual machines), (iv) implements access control and security mechanisms to isolate trust domain (e.g., trusted virtual machine) provided data from entities not in the TCB of a trust domain (e.g., a trusted virtual machine), (v) or any single or combination thereof.

In certain examples, secure startup service circuit 138 (e.g., one in each die or core) is a circuit (e.g., microcontroller) (e.g., separate from a core) with read-only memory (ROM) and random-access memory (RAM) for firmware execution. In certain examples, computer system 100 includes an in-package complex programmable logic device (CPLD) which provides non-volatile RAM to store code and the CPLD is shared by all the S3M (e.g., S3C) of a (e.g., central processing unit (CPU)) die.

In certain examples, secure startup service circuit 138 supports I/O controller functions (e.g., through a combination of hardware and firmware), e.g., for Universal Asynchronous Receiver Transmitter (UART) devices, Serial Peripheral Interface (SPI) devices, System Management Bus (SMBus) devices, etc.

In certain examples, the (e.g., on-die) S3M (e.g., S3C 138) accesses the (e.g., Peripheral Component Interconnect (PCI)) configuration space for a device under the (e.g., PCI) host bridge in same die so that the S3M (e.g., S3C) can send messages (e.g., SPDM messages) via a (e.g., PCI) Data Object Exchange (DOE) mailbox. Additionally or alternatively, the (e.g., on-die) S3M (e.g., S3C 138) accesses the I/O fabric interface 104 (e.g., SMBus) to send (e.g., SPDM) communications, e.g., over a Management Component Transport Protocol (MCTP) message.

In certain examples, the S3M (e.g., S3C 138) is also used during platform boot. For example, the platform hardware initialization manager (e.g., BIOS or UEFI) is to communicate with the S3M (e.g., S3C 138) and let S3M (e.g., S3C 138) send (e.g., SPDM) message to other device(s) 106 to collect the measurement. In certain examples, the S3M (e.g., S3C 138) is help to setup a SPDM session (e.g., and transport the IDE key). In certain examples, this boot time session has no relationship or interaction with setting up an instance of a secure communication session with the device 106.

Examples herein implement a TEE security manager (TSM) with computer system 100 (e.g., SOC coprocessor and/or microcontroller). In certain examples, a whole TSM includes two parts: (i) the trust domain manager 101 (e.g., one of 101-0 to 101-N) that enforces TEE isolation, and (ii) the S3C 138 that handles communications with the device security manager (DSM) 136.

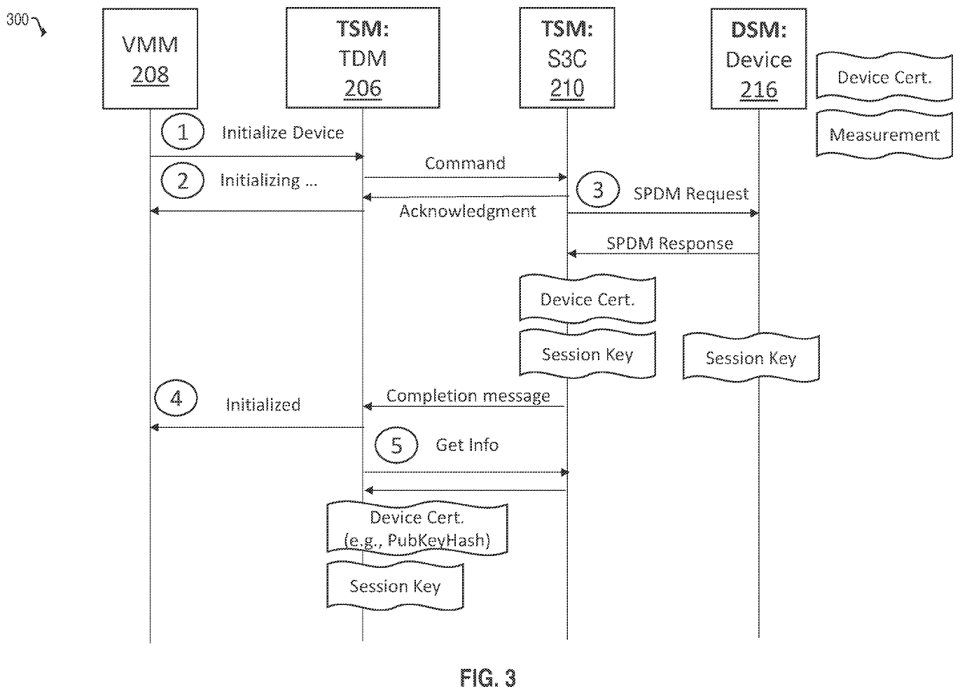

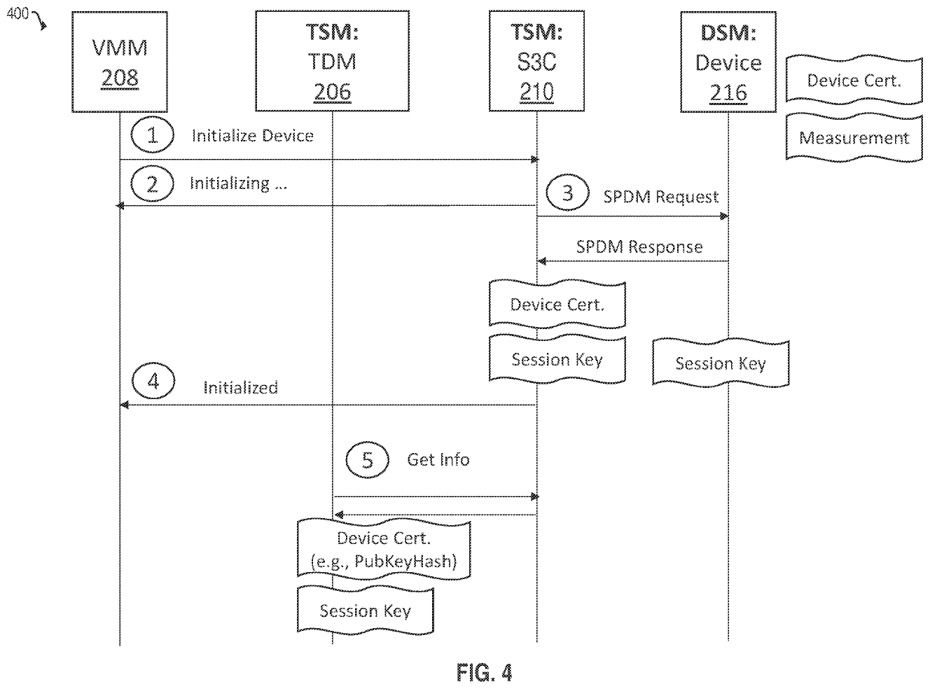

In certain examples, a standard defines a virtual machine monitor (VMM) (e.g., or VM thereof), TSM (e.g., trust domain manager 101 and S3C 138), and device security manager (DSM) 136 interaction flow. Examples are discussed in reference to FIGS. 3 and 4.

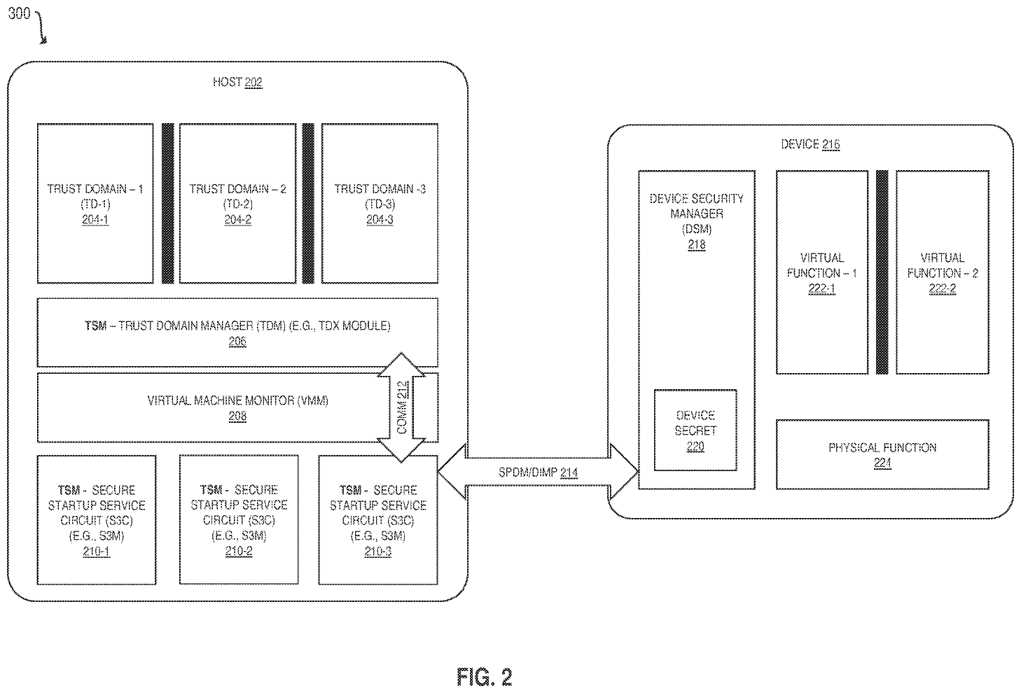

FIG. 2 illustrates a block diagram of a host 202 (e.g., one or more of processor cores 102 in FIG. 1) coupled to a device 216 (e.g., device 106 in FIG. 1) according to examples of the disclosure. In certain examples, host 202 implements a plurality of trust domains, shown as trust domain “1” 204-1, trust domain “2” 204-2, and trust domain “3” 204-3, although any single or plurality of trust domains may be implemented. In certain examples, host 202 includes a trust domain manager 206 to manage the trust domains (e.g., with the vertical black line indicating isolation therebetween the trust domains). In certain examples, the virtual machine monitor 208 manages (e.g., generates) one or more virtual machines, e.g., with the trust domain manager 206 isolating a first virtual machine as a first trust domain from a second (or more) virtual machine and second (or more) trust domain(s). In certain examples, the host 202 includes one or more secure startup service circuits (S3C), shown as secure startup service circuit “1” 210-1, secure startup service circuit “2” 210-2, and secure startup service circuit “3” 210-3.

In certain examples, the host 202 is coupled to device 216, e.g., via a coupling 214 (e.g., according to a transport level (e.g., SPDM) specification and/or an application level (e.g., DIMP) specification). In certain examples, device 216 includes a device security manager (DSM) 218 (e.g., as in instance of DSM 136 in FIG. 1) with a device secret(s) 220, e.g., device certificate, session key, device “measurement” values, etc. In certain examples, device 216 implements one or more physical function(s) 224 In certain examples, device 216 (e.g., according to a single-root input/output virtualization (SR-IOV) standard) is shared by a plurality of virtual machines (e.g., trust domains). In certain examples, a physical function 224 has the ability to move data in and out of the device while virtual functions 222 (for example, first virtual function 222-1 and second virtual function 222-2, e.g., with the vertical black line indicating isolation therebetween the virtual functions) are lightweight (e.g., PCI express (PCIe)) functions that support data flowing but also have a restricted set of configuration resources.

In certain examples, a whole TSM includes two parts: (i) the trust domain manager 206 that enforces TEE isolation, and (ii) a secure startup service circuit (S3C) 210 that handles communications with the device security manager (DSM) 218. In certain examples, the trust domain manager 206 sends a request (e.g., when requested by VMM 208) over communications 212 to secure startup service circuit (S3C) 210 (e.g., one of S3C 210-1, S3C 210-2, or S3C 210-3), and, in response, the secure startup service circuit and the device 216 (e.g., device security manager 218) generate a secure communication session (e.g., creating the session according to a SPDM standard and/or assigning a particular virtual function 222 to the trust domain manager 206 and/or a particular trust domain 204). In certain examples, the trust domain manager 206 is assigned a particular virtual function 222 and the trust domain manager 206 then assigns that particular virtual function to a particular trust domain 204.

In certain examples, the trust domain manager 206 relies on S3M (e.g., S3C 210) to communicate with the device 216 and setup a SPDM session, e.g., then S3M (e.g., S3C 210) passes the device information to the trust domain manager 206.

FIG. 3 is a swim lane diagram of a secure communication session (e.g., TSM) initialization flow 300 of a virtual machine manager (VMM) 208, trusted execution environment security manager (TSM) comprising a trust domain manager (TDM) 206 and a secure startup service circuit (S3C) 210, and a device 216 according to examples of the disclosure. Depicted flow 300 includes the following. At circle (1), the virtual machine monitor (VMM) 208 asks the trust domain manager (TDM) 206 to initialize the device 216. For example, with the Trust domain manager (TDM) 206 delegating the device initialization to S3M (e.g., S3C 210), by sending a command to S3M (e.g., S3C 210). Since there might be multiple S3Ms (e.g., S3Cs), in certain examples, the trust domain manager (TDM) 206 makes the decision about which S3M (e.g., S3C 210) to communicate with, e.g., based upon the device 216 location. At circle (2), once the S3M (e.g., S3C) command is sent, the trust domain manager (TDM) 206 returns an initializing acknowledgment to the virtual machine monitor (VMM) 208 (e.g., immediately) to let the system continue running. At this point, in certain examples the virtual machine monitor (VMM) 208 knows the TSM (e.g., TDM 206) is communicating with the device 216. In certain examples, a benign virtual machine monitor (VMM) 208 will not touch the device and/or a malicious virtual machine monitor (VMM) 208 may communicate with the device to interfere the communication. Because certain (e.g., the SPDM) protocols can resist the man-in-the-middle attack and guarantee the confidentiality and integrity of the communication, the S3M (e.g., S3C 210) detect an attack from a malicious virtual machine monitor (VMM) 208 and abort the communication (e.g., at circle (4)). At circle (3), once the S3M (e.g., S3C 210) receives the device initialization command, it sends a (e.g., SPDM) GET_VERSION (e.g., code value 0x84), GET_CAPABILITIES (e.g., code value 0xE1), and NEGOTIATE_ALGORITHM (e.g., code value 0xE3) command(s) to setup the connection with the device 216. After that, in certain examples, it uses GET_CERTIFICATE (e.g., code value 0x82) command to retrieve the device identity (e.g., the certificate chain). In certain examples, the S3M (e.g., S3C 210) uses KEY EXCHANGE command to setup a secure (e.g., SPDM) session with the device 216 with device authentication. In certain examples, the S3M (e.g., S3C 210) has the device certificate chain and a set of (e.g., SPDM) session keys (e.g., where the session key(s) are jointly generated by the device and the S3M). At circle (4), S3M (e.g., S3C 210) triggers a special interrupt to trust domain manager (TDM) 206 to notify the trust domain manager (TDM) 206 and/or the virtual machine monitor (VMM) 208 that the device 216 initialization is done. In certain examples, the Trust domain manager (TDM) 206 can notify the virtual machine monitor (VMM) 208 that the device is initialized. At circle (5), the trust domain manager (TDM) 206 can retrieve the device identity information (e.g., device public key hash from the device certificate chain) and the (e.g., SPDM) session keys from the S3M (e.g., S3C 210).

FIG. 4 shows another implementation choice where the virtual machine monitor (VMM) 208 can communicate with the S3M (e.g., S3C) directly to setup the (e.g., SPDM) secure session. FIG. 4 is a swim lane diagram of a secure communication session (e.g., TSM) initialization flow 400 of a virtual machine manager (VMM) 208, trusted execution environment security manager (TSM) comprising a trust domain manager (TDM) 206 and a secure startup service circuit (S3C) 210, and a device 216 wherein the VMM 208 communicates with the S3C 210 directly according to examples of the disclosure. In certain examples, the operations at circles (1), (2) and (3) are as discussed in reference to FIG. 3, except that the virtual machine monitor (VMM) 208 directly requests the S3M (e.g., S3C 210) to perform the (e.g., SPDM) communications and the S3M (e.g., S3C 210) notifies the virtual machine monitor (VMM) 208 directly after the initialization is done. In certain examples, because the virtual machine monitor (VMM) 208 is not trusted, the S3M (e.g., S3C 210) shall not return any sensitive information to the virtual machine monitor (VMM) 208, such as, but not limited to (e.g., SPDM) session keys.

At circle (3), the S3M (e.g., S3C 210) may use DOE mailbox or use MCTP. For the MCTP, the S3M (e.g., S3C 210) may relay the MCTP message through the platform (e.g., a baseboard management controller (BMC) in the platform). In certain examples, once the trust domain manager (TDM) 206 gets the device information and the (e.g., SPDM) session information, the S3M (e.g., S3C 210) is not needed, e.g., the rest of the TSM work can be done by the trust domain manager (TDM) 206.

In certain examples, the trust domain manager (TDM) 206 can own the communication with the device because it has the (e.g., SPDM) session keys. In certain examples, the trust domain manager (TDM) 206 knows the device identity because it has the device certificate (e.g., public key hash).

### Security Considerations

In certain examples, the communications between the S3M (e.g., S3C) and the device are protected by a security (e.g., SPDM) protocol. In certain examples, the communications between the trust domain manager (TDM) and S3M (e.g., S3C) are also protected. In certain examples, the S3M (e.g., S3C) is part of a processor (e.g., separate from a core) (e.g., the uncore). In certain examples, the S3M (e.g., S3C) exposes a set of registers which is only accessible by the trust domain manager (TDM) in a corresponding (e.g., SEAM) mode. As such, in certain examples, only the trust domain manager (TDM) 206 sends the device initialization request and it sends the device information to the S3M (e.g., S3C). In certain examples, the communications between the S3M (e.g., S3C) and the trust domain manager (TDM) 206 are inside of a (e.g., CPU) SOC die, e.g., and thus secure from being hijacked on the communication bus between the S3M (e.g., S3C) and trust domain manager (TDM).

### Attestation

In certain examples, the TDX-IO remote attestation covers both TDX attestation and S3M (e.g., S3C) attestation. For example, where first, the verifier needs to perform a TDX attestation to ensure the trust domain manager (TDM) 206 and TD are good (e.g., trusted), e.g., according to a TDX attestation, and, second, the verifier is to use SPDM based attestation to verify the S3M (e.g., S3C) is good (e.g., trusted), e.g., according to a S3M (e.g., S3C) attestation.

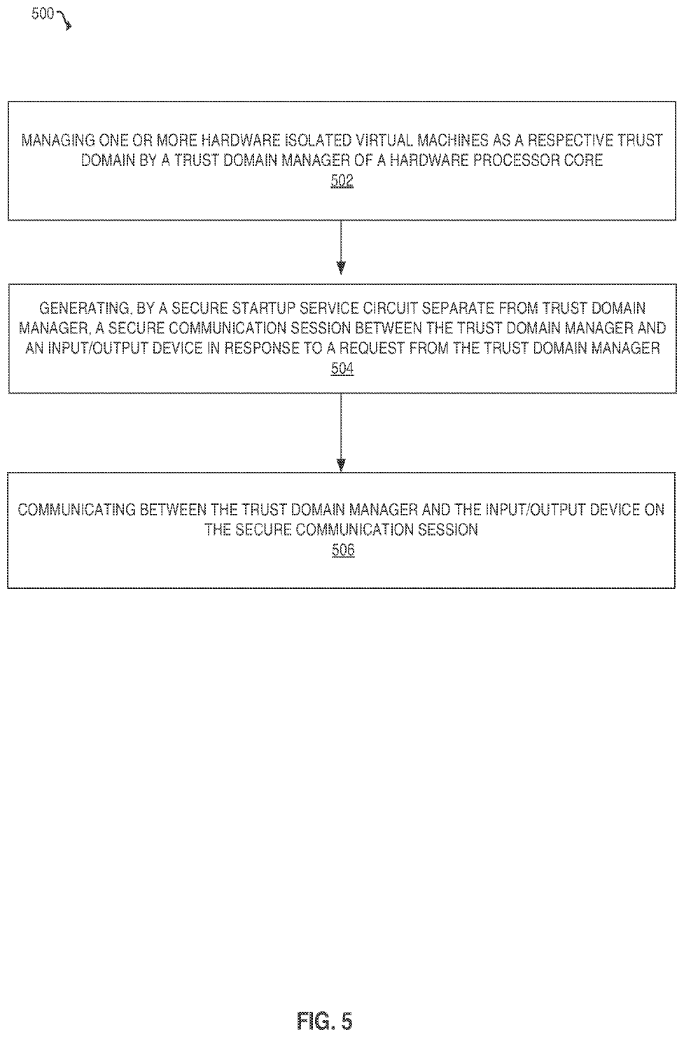

FIG. 5 is a flow diagram illustrating operations 500 of a method of generating a secure communication session according to examples of the disclosure. Some or all of the operations 500 (or other processes described herein, or variations, and/or combinations thereof) are performed under the control of a TSM as implemented herein and/or one or more computer systems configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 500 are performed by a host (e.g., trust domain manager and S3C) of the other figures.

The operations 500 include, at block 502, managing one or more hardware isolated virtual machines as a respective trust domain by a trust domain manager of a hardware processor core. The operations 500 further include, at block 504, generating, by a secure startup service circuit separate from the trust domain manager, a secure communication session between the trust domain manager and an input/output device in response to a request from the trust domain manager. The operations 500 further include, at block 506, communicating between the trust domain manager and the input/output device on the secure communication session.

In certain examples, a virtual machine (e.g., a trusted domain) is to request use of a device such that the device performs a direct memory access (DMA). In certain examples, a virtual machine (e.g., a trusted domain) is to request use of a device according to one or more instructions, e.g., after the secure communication session with that device and virtual machine (e.g., a trusted domain) is generated.

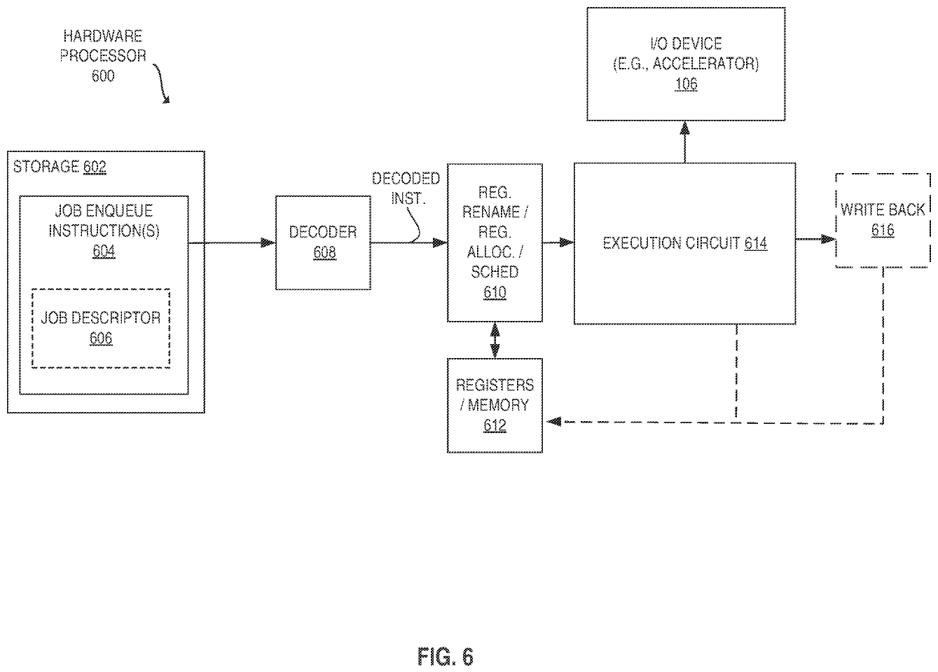

FIG. 6 illustrates a hardware processor 600 coupled to storage 602 that includes one or more job enqueue instructions 604 according to examples of the disclosure. In certain examples, job enqueue instruction is according to any of the disclosure herein. In certain examples, job enqueue instruction 604 identifies a job descriptor 606 (e.g., and the (e.g., logical) MMIO address of a device 106 (e.g., accelerator).

In one example, e.g., in response to a request to perform an operation, the instruction (e.g., macro-instruction) is fetched from storage 602 and sent to decoder 608. In the depicted example, the decoder 608 (e.g., decoder circuit) decodes the instruction into a decoded instruction (e.g., one or more micro-instructions or micro-operations). The decoded instruction is then sent for execution, e.g., via scheduler circuit 610 to schedule the decoded instruction for execution.

In certain examples, (e.g., where the processor/core supports out-of-order (OoO) execution), the processor includes a register rename/allocator circuit 610 coupled to register file/memory circuit 612 (e.g., unit) to allocate resources and perform register renaming on registers (e.g., registers associated with the initial sources and final destination of the instruction). In certain examples, (e.g., for out-of-order execution), the processor includes one or more scheduler circuits 610 coupled to the decoder 608. The scheduler circuit(s) may schedule one or more operations associated with decoded instructions, including one or more operations decoded from a job enqueue instruction 604, e.g., for offloading execution of an operation to device 106 by the execution circuit 614.

In certain examples, a write back circuit 616 is included to write back results of an instruction to a destination (e.g., write them to a register(s) and/or memory), for example, so those results are visible within a processor (e.g., visible outside of the execution circuit that produced those results).

One or more of these components (e.g., decoder 608, register rename/register allocator/scheduler 610, execution circuit 614, registers (e.g., register file)/memory 612, or write back circuit 616) may be in a single core of a hardware processor (e.g., and multiple cores each with an instance of these components).

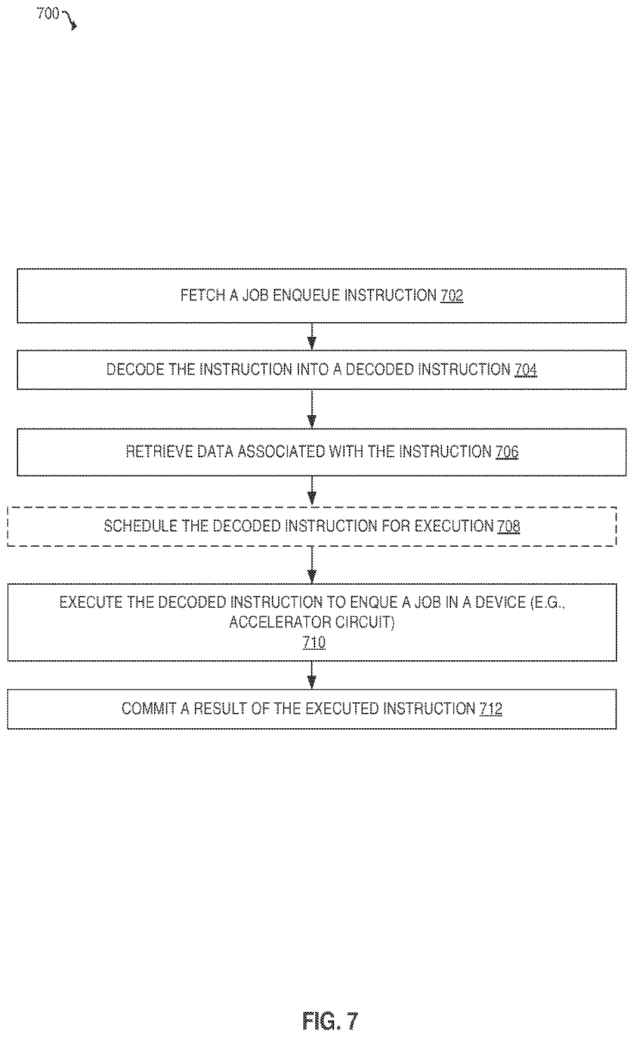

FIG. 7 is a flow diagram illustrating operations 700 of a method for processing a job enqueue instruction according to examples of the disclosure. A processor (e.g., or processor core) may perform operations 700 of method, e.g., in response to receiving a request to execute an instruction from software. Depicted operations 700 includes processing a “job enqueue” instruction by performing a: fetch of an instruction (e.g., having an instruction opcode corresponding to the job enqueue mnemonic) 702, decode of the instruction into a decoded instruction 704, retrieve data associated with the instruction 706, (optionally) schedule the decoded instruction for execution 708, execute the decoded instruction to enqueue a job in a device (e.g., accelerator circuit) 710, and commit a result of the executed instruction 712.

Exemplary architectures, systems, etc. that the above may be used in are detailed below. Exemplary instruction formats that may cause enqueuing of a job for an accelerator are detailed below.

At least some examples of the disclosed technologies can be described in view of the following examples:
Example 1. An apparatus comprising:
   a hardware processor core comprising a trust domain manager to manage one or more hardware isolated virtual machines as a respective trust domain;
   a coupling between the hardware processor core and an input/output device; and
   a secure startup service circuit separate from the trust domain manager to, in response to a request from the trust domain manager, generate a secure communication session between the trust domain manager and the input/output device.
Example 2. The apparatus of example 1, wherein the secure startup service circuit is to generate the secure communication session between the trust domain manager and the input/output device without stalling the trust domain manager of the hardware processor core until the generation of the secure communication session is complete.
Example 3. The apparatus of example 1, wherein the secure communication session is according to a Security Protocol and Data Model (SPDM) standard.
Example 4. The apparatus of example 3, wherein the secure communication session is also according to a Device Interface Management Protocol (DIMP) standard.
Example 5. The apparatus of example 1, wherein the secure startup service circuit is to communicate with the input/output device to setup the secure communication session comprising a device certificate, and send the device certificate for the input/output device to the trust domain manager of the hardware processor core to generate the secure communication session between the trust domain manager and the input/output device.
Example 6. The apparatus of example 1, wherein the secure startup service circuit is to communicate with the input/output device to setup the secure communication session comprising a session key, and send the session key to the trust domain manager of the hardware processor core to generate the secure communication session between the trust domain manager and the input/output device.
Example 7. The apparatus of example 1, wherein the secure startup service circuit is to communicate with the input/output device to setup the secure communication session comprising a session key and a device certificate, and send the session key and the device certificate for the input/output device to the trust domain manager of the hardware processor core to generate the secure communication session between the trust domain manager and the input/output device.
Example 8. The apparatus of any one of examples 1-7, wherein the request from the trust domain manager is caused by a request from a hardware isolated virtual machine, as a trust domain, to access the input/output device by the secure communication session.
Example 9. A method comprising:
   managing one or more hardware isolated virtual machines as a respective trust domain by a trust domain manager of a hardware processor core;
   generating, by a secure startup service circuit separate from the trust domain manager, a secure communication session between the trust domain manager and an input/output device in response to a request from the trust domain manager; and communicating between the trust domain manager and the input/output device on the secure communication session.
Example 10. The method of example 9, wherein the generating the secure communication session between the trust domain manager and the input/output device is without stalling the trust domain manager of the hardware processor core until the generation of the secure communication session is complete.
Example 11. The method of example 9, wherein the secure communication session is according to a Security Protocol and Data Model (SPDM) standard.
Example 12. The method of example 11, wherein the secure communication session is also according to a Device Interface Management Protocol (DIMP) standard.
Example 13. The method of example 9, wherein the generating comprises:
   communicating by the secure startup service circuit with the input/output device to setup the secure communication session comprising a device certificate; and
   sending the device certificate for the input/output device to the trust domain manager of the hardware processor core to generate the secure communication session between the trust domain manager and the input/output device.
Example 14. The method of example 9, wherein the generating comprises:
   communicating by the secure startup service circuit with the input/output device to setup the secure communication session comprising a session key; and
   sending the session key to the trust domain manager of the hardware processor core to generate the secure communication session between the trust domain manager and the input/output device.
Example 15. The method of example 9, wherein the generating comprises:
   communicating by the secure startup service circuit with the input/output device to setup the secure communication session comprising a session key and a device certificate; and
   sending the session key and the device certificate for the input/output device to the trust domain manager of the hardware processor core to generate the secure communication session between the trust domain manager and the input/output device.
Example 16. The method of any one of examples 9-15, further comprising sending a request from a hardware isolated virtual machine, as a trust domain, to access the input/output device by the secure communication session, wherein the request from the hardware isolated virtual machine causes the request to be sent from the trust domain manager to the secure startup service circuit.
Example 17. A system comprising:
   a hardware processor core comprising a trust domain manager to manage one or more hardware isolated virtual machines as a respective trust domain;
   an input/output device coupled to the hardware processor core; and
   a secure startup service circuit separate from the trust domain manager to, in response to a request from the trust domain manager, generate a secure communication session between the trust domain manager and the input/output device.
Example 18. The system of example 17, wherein the secure startup service circuit is to generate the secure communication session between the trust domain manager and the input/output device without stalling the trust domain manager of the hardware processor core until the generation of the secure communication session is complete.
Example 19. The system of example 17, wherein the secure communication session is according to a Security Protocol and Data Model (SPDM) standard.
Example 20. The system of example 19, wherein the secure communication session is also according to a Device Interface Management Protocol (DIMP) standard.
Example 21. The system of example 17, wherein the secure startup service circuit is to communicate with the input/output device to setup the secure communication session comprising a device certificate, and send the device certificate for the input/output device to the trust domain manager of the hardware processor core to generate the secure communication session between the trust domain manager and the input/output device.
Example 22. The system of example 17, wherein the secure startup service circuit is to communicate with the input/output device to setup the secure communication session comprising a session key, and send the session key to the trust domain manager of the hardware processor core to generate the secure communication session between the trust domain manager and the input/output device.
Example 23. The system of example 17, wherein the secure startup service circuit is to communicate with the input/output device to setup the secure communication session comprising a session key and a device certificate, and send the session key and the device certificate for the input/output device to the trust domain manager of the hardware processor core to generate the secure communication session between the trust domain manager and the input/output device.
Example 24. The system of any one of examples 17-23, wherein the request from the trust domain manager is caused by a request from a hardware isolated virtual machine, as a trust domain, to access the input/output device by the secure communication session.

In yet another example, an apparatus comprises a data storage device that stores code that when executed by a hardware processor causes the hardware processor to perform any method disclosed herein. An apparatus may be as described in the detailed description. A method may be as described in the detailed description.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, November 2018; and see Intel® Architecture Instruction Set Extensions Programming Reference, October 2018).

### Exemplary Instruction Formats

Examples of the instruction(s) described herein may be embodied in different formats. Additionally, exemplary systems, architectures, and pipelines are detailed below. Examples of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While examples are described in which both vector and scalar operations are supported through the vector friendly instruction format, alternative examples use only vector operations the vector friendly instruction format.

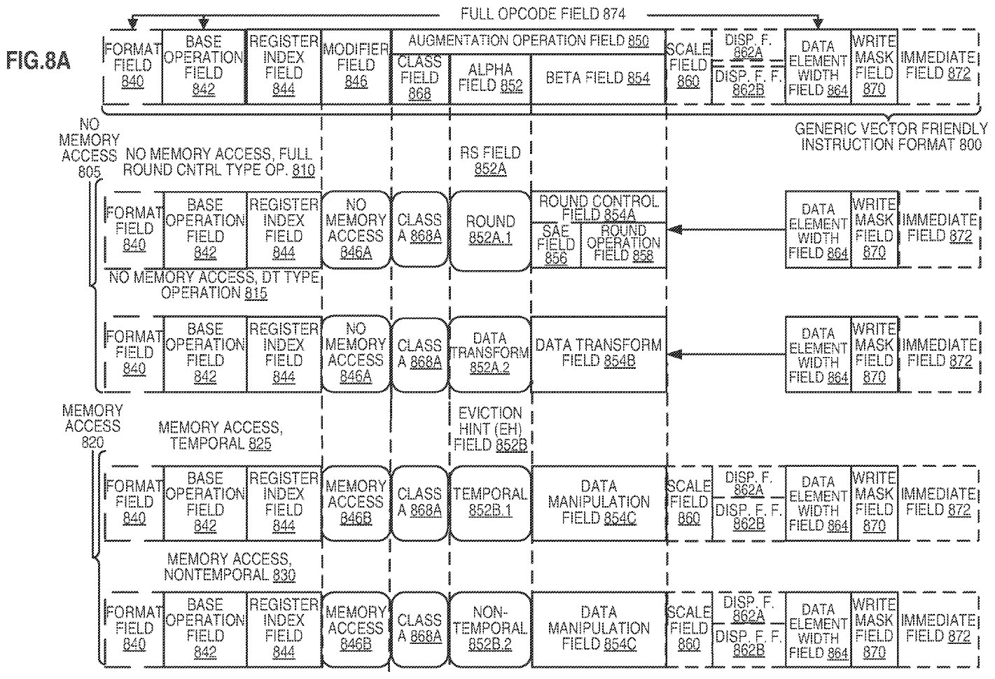

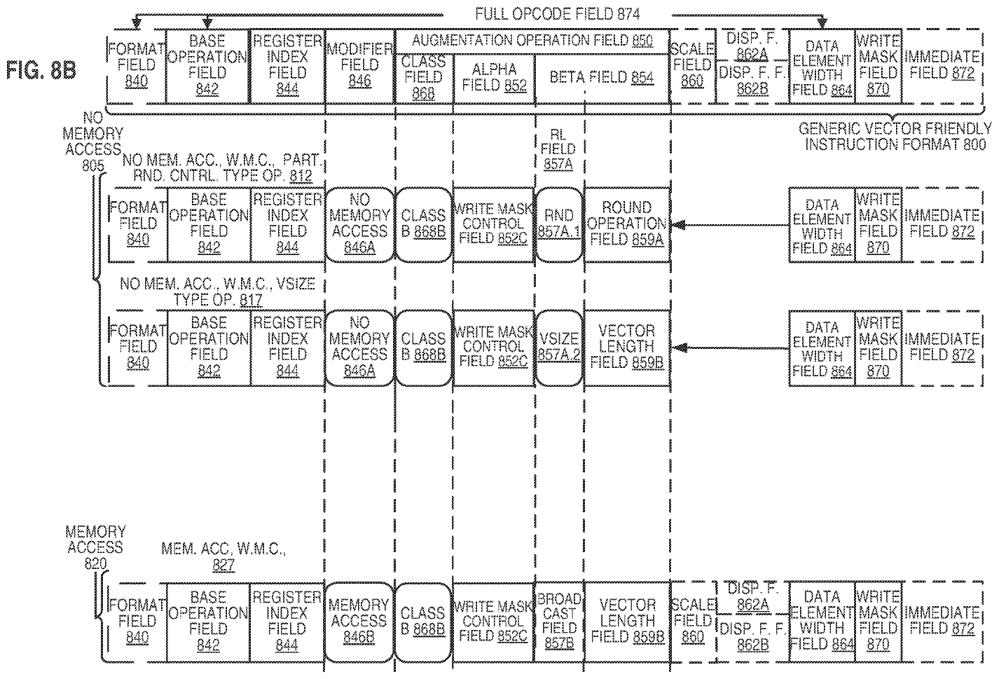

FIGS. 8A-8B are block diagrams illustrating a generic vector friendly instruction format and instruction templates thereof according to examples of the disclosure. FIG. 8A is a block diagram illustrating a generic vector friendly instruction format and class A instruction templates thereof according to examples of the disclosure; while FIG. 8B is a block diagram illustrating the generic vector friendly instruction format and class B instruction templates thereof according to examples of the disclosure. Specifically, a generic vector friendly instruction format 800 for which are defined class A and class B instruction templates, both of which include no memory access 805 instruction templates and memory access 820 instruction templates. The term generic in the context of the vector friendly instruction format refers to the instruction format not being tied to any specific instruction set.

While examples of the disclosure will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative examples may support more, less and/or different vector operand sizes (e.g., 256 byte vector operands) with more, less, or different data element widths (e.g., 128 bit (16 byte) data element widths).

The class A instruction templates in FIG. 8A include: 1) within the no memory access 805 instruction templates there is shown a no memory access, full round control type operation 810 instruction template and a no memory access, data transform type operation 815 instruction template; and 2) within the memory access 820 instruction templates there is shown a memory access, temporal 825 instruction template and a memory access, non-temporal 830 instruction template. The class B instruction templates in FIG. 8B include: 1) within the no memory access 805 instruction templates there is shown a no memory access, write mask control, partial round control type operation 812 instruction template and a no memory access, write mask control, vsize type operation 817 instruction template; and 2) within the memory access 820 instruction templates there is shown a memory access, write mask control 827 instruction template.

The generic vector friendly instruction format 800 includes the following fields listed below in the order illustrated in FIGS. 8A-8B.

Format field 840—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 842—its content distinguishes different base operations.

Register index field 844—its content, directly or through address generation, specifies the locations of the source and destination operands, be they in registers or in memory. These include a sufficient number of bits to select N registers from a P×Q (e.g., 32×512, 16×128, 32×1024, 64×1024) register file. While in one example N may be up to three sources and one destination register, alternative examples may support more or less sources and destination registers (e.g., may support up to two sources where one of these sources also acts as the destination, may support up to three sources where one of these sources also acts as the destination, may support up to two sources and one destination).

Modifier field 846—its content distinguishes occurrences of instructions in the generic vector instruction format that specify memory access from those that do not; that is, between no memory access 805 instruction templates and memory access 820 instruction templates. Memory access operations read and/or write to the memory hierarchy (in some cases specifying the source and/or destination addresses using values in registers), while non-memory access operations do not (e.g., the source and destinations are registers). While in one example this field also selects between three different ways to perform memory address calculations, alternative examples may support more, less, or different ways to perform memory address calculations.

Augmentation operation field 850—its content distinguishes which one of a variety of different operations to be performed in addition to the base operation. This field is context specific. In one example of the disclosure, this field is divided into a class field 868, an alpha field 852, and a beta field 854. The augmentation operation field 850 allows common groups of operations to be performed in a single instruction rather than 2, 3, or 4 instructions.

Scale field 860—its content allows for the scaling of the index field's content for memory address generation (e.g., for address generation that uses 2^{scale}*index+base).

Displacement Field 862A—its content is used as part of memory address generation (e.g., for address generation that uses 2^{scale}*index+base+displacement).

Displacement Factor Field 862B (note that the juxtaposition of displacement field 862A directly over displacement factor field 862B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 874 (described later herein) and the data manipulation field 854C. The displacement field 862A and the displacement factor field 862B are optional in the sense that they are not used for the no memory access 805 instruction templates and/or different examples may implement only one or none of the two.

Data element width field 864—its content distinguishes which one of a number of data element widths is to be used (in some examples for all instructions; in other examples for only some of the instructions). This field is optional in the sense that it is not needed if only one data element width is supported and/or data element widths are supported using some aspect of the opcodes.

Write mask field 870—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 870 allows for partial vector operations, including loads, stores, arithmetic, logical, etc. While examples of the disclosure are described in which the write mask field's 870 content selects one of a number of write mask registers that contains the write mask to be used (and thus the write mask field's 870 content indirectly identifies that masking to be performed), alternative examples instead or additional allow the mask write field's 870 content to directly specify the masking to be performed.

Immediate field 872—its content allows for the specification of an immediate. This field is optional in the sense that is it not present in an implementation of the generic vector friendly format that does not support immediate and it is not present in instructions that do not use an immediate.

Class field 868—its content distinguishes between different classes of instructions. With reference to FIGS. 8A-B, the contents of this field select between class A and class B instructions. In FIGS. 8A-B, rounded corner squares are used to indicate a specific value is present in a field (e.g., class A 868A and class B 868B for the class field 868 respectively in FIGS. 8A-B).

### Instruction Templates of Class A

In the case of the non-memory access 805 instruction templates of class A, the alpha field 852 is interpreted as an RS field 852A, whose content distinguishes which one of the different augmentation operation types are to be performed (e.g., round 852A.1 and data transform 852A.2 are respectively specified for the no memory access, round type operation 810 and the no memory access, data transform type operation 815 instruction templates), while the beta field 854 distinguishes which of the operations of the specified type is to be performed. In the no memory access 805 instruction templates, the scale field 860, the displacement field 862A, and the displacement scale filed 862B are not present.

### No-Memory Access Instruction Templates—Full Round Control Type Operation

In the no memory access full round control type operation 810 instruction template, the beta field 854 is interpreted as a round control field 854A, whose content(s) provide static rounding. While in the described examples of the disclosure the round control field 854A includes a suppress all floating point exceptions (SAE) field 856 and a round operation control field 858, alternative examples may support may encode both these concepts into the same field or only have one or the other of these concepts/fields (e.g., may have only the round operation control field 858).

SAE field 856—its content distinguishes whether or not to disable the exception event reporting; when the SAE field's 856 content indicates suppression is enabled, a given instruction does not report any kind of floating-point exception flag and does not raise any floating point exception handler.

Round operation control field 858—its content distinguishes which one of a group of rounding operations to perform (e.g., Round-up, Round-down, Round-towards-zero and Round-to-nearest). Thus, the round operation control field 858 allows for the changing of the rounding mode on a per instruction basis. In one example of the disclosure where a processor includes a control register for specifying rounding modes, the round operation control field's 850 content overrides that register value.

### No Memory Access Instruction Templates—Data Transform Type Operation

In the no memory access data transform type operation 815 instruction template, the beta field 854 is interpreted as a data transform field 854B, whose content distinguishes which one of a number of data transforms is to be performed (e.g., no data transform, swizzle, broadcast).

In the case of a memory access 820 instruction template of class A, the alpha field 852 is interpreted as an eviction hint field 852B, whose content distinguishes which one of the eviction hints is to be used (in FIG. 8A, temporal 852B.1 and non-temporal 852B.2 are respectively specified for the memory access, temporal 825 instruction template and the memory access, non-temporal 830 instruction template), while the beta field 854 is interpreted as a data manipulation field 854C, whose content distinguishes which one of a number of data manipulation operations (also known as primitives) is to be performed (e.g., no manipulation; broadcast; up conversion of a source; and down conversion of a destination). The memory access 820 instruction templates include the scale field 860, and optionally the displacement field 862A or the displacement scale field 862B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 852 is interpreted as a write mask control (Z) field 852C, whose content distinguishes whether the write masking controlled by the write mask field 870 should be a merging or a zeroing.

In the case of the non-memory access 805 instruction templates of class B, part of the beta field 854 is interpreted as an RL field 857A, whose content distinguishes which one of the different augmentation operation types are to be performed (e.g., round 857A.1 and vector length (VSIZE) 857A.2 are respectively specified for the no memory access, write mask control, partial round control type operation 812 instruction template and the no memory access, write mask control, VSIZE type operation 817 instruction template), while the rest of the beta field 854 distinguishes which of the operations of the specified type is to be performed. In the no memory access 805 instruction templates, the scale field 860, the displacement field 862A, and the displacement scale filed 862B are not present.

In the no memory access, write mask control, partial round control type operation 810 instruction template, the rest of the beta field 854 is interpreted as a round operation field 859A and exception event reporting is disabled (a given instruction does not report any kind of floating-point exception flag and does not raise any floating point exception handler).

Round operation control field 859A-just as round operation control field 858, its content distinguishes which one of a group of rounding operations to perform (e.g., Round-up, Round-down, Round-towards-zero and Round-to-nearest). Thus, the round operation control field 859A allows for the changing of the rounding mode on a per instruction basis. In one example of the disclosure where a processor includes a control register for specifying rounding modes, the round operation control field's 850 content overrides that register value.

In the no memory access, write mask control, VSIZE type operation 817 instruction template, the rest of the beta field 854 is interpreted as a vector length field 859B, whose content distinguishes which one of a number of data vector lengths is to be performed on (e.g., 128, 256, or 512 byte).

In the case of a memory access 820 instruction template of class B, part of the beta field 854 is interpreted as a broadcast field 857B, whose content distinguishes whether or not the broadcast type data manipulation operation is to be performed, while the rest of the beta field 854 is interpreted the vector length field 859B. The memory access 820 instruction templates include the scale field 860, and optionally the displacement field 862A or the displacement scale field 862B.

With regard to the generic vector friendly instruction format 800, a full opcode field 874 is shown including the format field 840, the base operation field 842, and the data element width field 864. While one example is shown where the full opcode field 874 includes all of these fields, the full opcode field 874 includes less than all of these fields in examples that do not support all of them. The full opcode field 874 provides the operation code (opcode).

The augmentation operation field 850, the data element width field 864, and the write mask field 870 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some examples of the disclosure, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the disclosure). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different examples of the disclosure. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

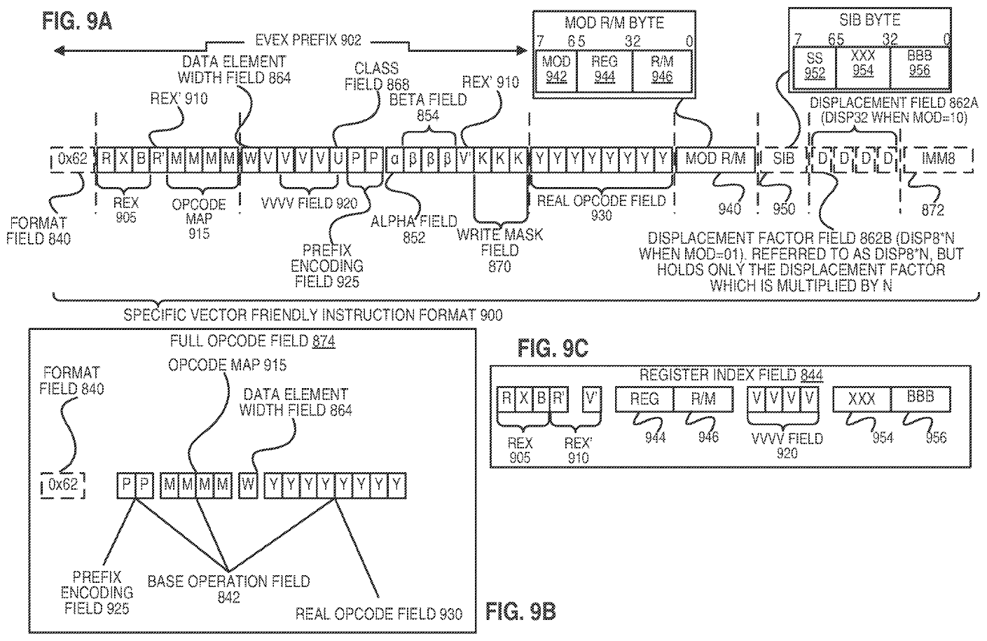

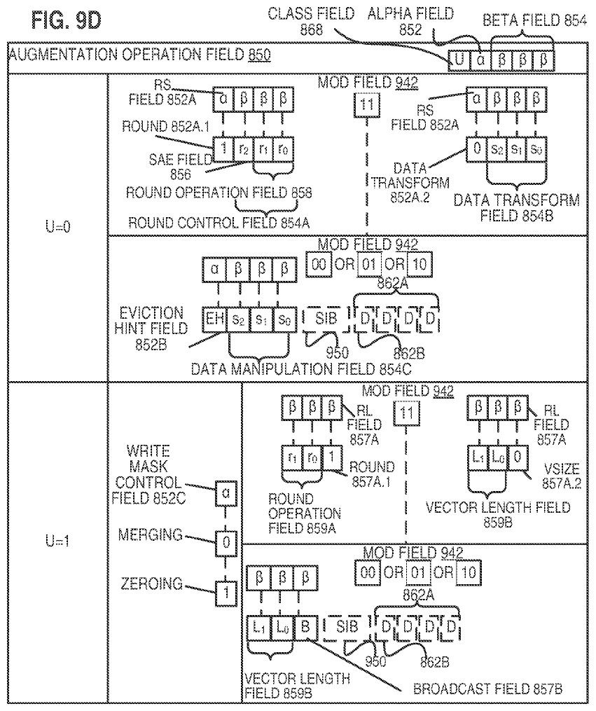

FIG. 9 is a block diagram illustrating an exemplary specific vector friendly instruction format according to examples of the disclosure. FIG. 9 shows a specific vector friendly instruction format 900 that is specific in the sense that it specifies the location, size, interpretation, and order of the fields, as well as values for some of those fields. The specific vector friendly instruction format 900 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 8 into which the fields from FIG. 9 map are illustrated.

It should be understood that, although examples of the disclosure are described with reference to the specific vector friendly instruction format 900 in the context of the generic vector friendly instruction format 800 for illustrative purposes, the disclosure is not limited to the specific vector friendly instruction format 900 except where claimed. For example, the generic vector friendly instruction format 800 contemplates a variety of possible sizes for the various fields, while the specific vector friendly instruction format 900 is shown as having fields of specific sizes. By way of specific example, while the data element width field 864 is illustrated as a one bit field in the specific vector friendly instruction format 900, the disclosure is not so limited (that is, the generic vector friendly instruction format 800 contemplates other sizes of the data element width field 864).

The generic vector friendly instruction format 800 includes the following fields listed below in the order illustrated in FIG. 9A.

EVEX Prefix (Bytes 0-3) 902—is encoded in a four-byte form.

Format Field 840 (EVEX Byte 0, bits [7:0])—the first byte (EVEX Byte 0) is the format field 840 and it contains 0x62 (the unique value used for distinguishing the vector friendly instruction format in one example of the disclosure).

The second-fourth bytes (EVEX Bytes 1-3) include a number of bit fields providing specific capability.

REX field 905 (EVEX Byte 1, bits [7-5])—consists of an EVEX.R bit field (EVEX Byte 1, bit [7]-R), EVEX.X bit field (EVEX byte 1, bit [6]-X), and 857BEX byte 1, bit[5]-B). The EVEX.R, EVEX.X, and EVEX.B bit fields provide the same functionality as the corresponding VEX bit fields, and are encoded using Is complement form, e.g., ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 810—this is the first part of the REX′ field 810 and is the EVEX.R′ bit field (EVEX Byte 1, bit [4]-R′) that is used to encode either the upper 16 or lower 16 of the extended 32 register set. In one example of the disclosure, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative examples of the disclosure do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 915 (EVEX byte 1, bits [3:0]-mmmm)—its content encodes an implied leading opcode byte (0F, 0F 38, or 0F 3).

Data element width field 864 (EVEX byte 2, bit [7]-W)—is represented by the notation EVEX.W. EVEX.W is used to define the granularity (size) of the datatype (either 32-bit data elements or 64-bit data elements).

EVEX.vvvv 920 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in Is complement form for certain vector shifts; or 3) EVEX.vvvv does not encode any operand, the field is reserved and should contain 1111b. Thus, EVEX.vvvv field 920 encodes the 4 low-order bits of the first source register specifier stored in inverted (1s complement) form. Depending on the instruction, an extra different EVEX bit field is used to extend the specifier size to 32 registers.

EVEX.U 868 Class field (EVEX byte 2, bit [2]-U)—If EVEX.U=0, it indicates class A or EVEX.U0; if EVEX.U=1, it indicates class B or EVEX.U1.

Prefix encoding field 925 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one example, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain examples expand in a similar fashion for consistency but allow for different meanings to be specified by these legacy SIMD prefixes. An alternative example may redesign the PLA to support the 2 bit SIMD prefix encodings, and thus not require the expansion.

Alpha field 852 (EVEX byte 3, bit [7]-EH; also known as EVEX.EH, EVEX.rs, EVEX.RL, EVEX.write mask control, and EVEX.N; also illustrated with α)—as previously described, this field is context specific.

Beta field 854 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 810—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 870 (EVEX byte 3, bits [2:0]-kkk)—its content specifies the index of a register in the write mask registers as previously described. In one example of the disclosure, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 930 (Byte 4) is also known as the opcode byte. Part of the opcode is specified in this field.

MOD R/M Field 940 (Byte 5) includes MOD field 942, Reg field 944, and R/M field 946. As previously described, the MOD field's 942 content distinguishes between memory access and non-memory access operations. The role of Reg field 944 can be summarized to two situations: encoding either the destination register operand or a source register operand, or be treated as an opcode extension and not used to encode any instruction operand. The role of R/M field 946 may include the following: encoding the instruction operand that references a memory address, or encoding either the destination register operand or a source register operand.

Scale, Index, Base (SIB) Byte (Byte 6)—As previously described, the scale field's 850 content is used for memory address generation. SIB.xxx 954 and SIB.bbb 956—the contents of these fields have been previously referred to with regard to the register indexes Xxxx and Bbbb.

Displacement field 862A (Bytes 7-10)—when MOD field 942 contains 10, bytes 7-10 are the displacement field 862A, and it works the same as the legacy 32-bit displacement (disp32) and works at byte granularity.

Displacement factor field 862B (Byte 7)—when MOD field 942 contains 01, byte 7 is the displacement factor field 862B. The location of this field is that same as that of the legacy x86 instruction set 8-bit displacement (disp8), which works at byte granularity. Since disp8 is sign extended, it can only address between-128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 862B is a reinterpretation of disp8; when using displacement factor field 862B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 862B substitutes the legacy x86 instruction set 8-bit displacement. Thus, the displacement factor field 862B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 872 operates as previously described.

### Full Opcode Field

FIG. 9B is a block diagram illustrating the fields of the specific vector friendly instruction format 900 that make up the full opcode field 874 according to one example of the disclosure. Specifically, the full opcode field 874 includes the format field 840, the base operation field 842, and the data element width (W) field 864. The base operation field 842 includes the prefix encoding field 925, the opcode map field 915, and the real opcode field 930.

### Register Index Field

FIG. 9C is a block diagram illustrating the fields of the specific vector friendly instruction format 900 that make up the register index field 844 according to one example of the disclosure. Specifically, the register index field 844 includes the REX field 905, the REX′ field 910, the MODR/M.reg field 944, the MODR/M.r/m field 946, the VVVV field 920, xxx field 954, and the bbb field 956.

### Augmentation Operation Field

FIG. 9D is a block diagram illustrating the fields of the specific vector friendly instruction format 900 that make up the augmentation operation field 850 according to one example of the disclosure. When the class (U) field 868 contains 0, it signifies EVEX.U0 (class A 868A); when it contains 1, it signifies EVEX.U1 (class B 868B). When U=0 and the MOD field 942 contains 11 (signifying a no memory access operation), the alpha field 852 (EVEX byte 3, bit [7]-EH) is interpreted as the rs field 852A. When the rs field 852A contains a 1 (round 852A.1), the beta field 854 (EVEX byte 3, bits [6:4]-SSS) is interpreted as the round control field 854A. The round control field 854A includes a one bit SAE field 856 and a two bit round operation field 858. When the rs field 852A contains a 0 (data transform 852A.2), the beta field 854 (EVEX byte 3, bits [6:4]-SSS) is interpreted as a three bit data transform field 854B. When U=0 and the MOD field 942 contains 00, 01, or 10 (signifying a memory access operation), the alpha field 852 (EVEX byte 3, bit [7]-EH) is interpreted as the eviction hint (EH) field 852B and the beta field 854 (EVEX byte 3, bits [6:4]-SSS) is interpreted as a three bit data manipulation field 854C.

When U=1, the alpha field 852 (EVEX byte 3, bit [7]-EH) is interpreted as the write mask control (Z) field 852C. When U=1 and the MOD field 942 contains 11 (signifying a no memory access operation), part of the beta field 854 (EVEX byte 3, bit [4]-S₀) is interpreted as the RL field 857A; when it contains a 1 (round 857A.1) the rest of the beta field 854 (EVEX byte 3, bit [6-5]-S₂₋₁) is interpreted as the round operation field 859A, while when the RL field 857A contains a 0 (VSIZE 857.A2) the rest of the beta field 854 (EVEX byte 3, bit [6-5]-S₂₋₁) is interpreted as the vector length field 859B (EVEX byte 3, bit [6-5]-L₁₋₀). When U=1 and the MOD field 942 contains 00, 01, or 10 (signifying a memory access operation), the beta field 854 (EVEX byte 3, bits [6:4]-SSS) is interpreted as the vector length field 859B (EVEX byte 3, bit [6-5]-L₁₋₀) and the broadcast field 857B (EVEX byte 3, bit [4]-B).

### Exemplary Register Architecture

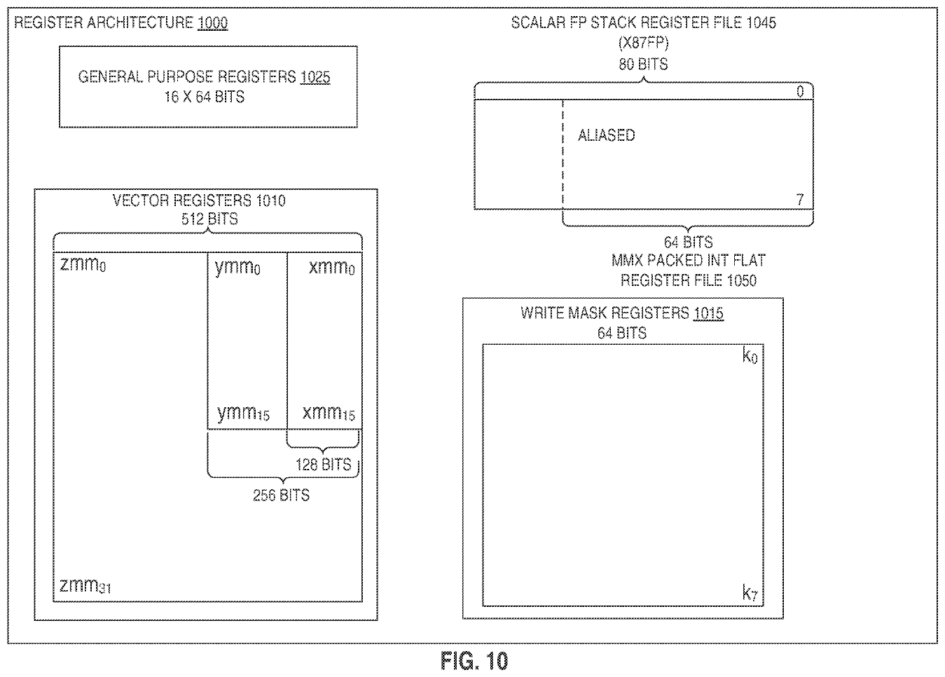

FIG. 10 is a block diagram of a register architecture 1000 according to one example of the disclosure. In the example illustrated, there are 32 vector registers 1010 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 900 operates on these overlaid register file as illustrated in the below tables.

| Adjustable Vector | | | |
|---|---|---|---|
| Length | Class | Operations | Registers |
| Instruction Templates | A | 810, 815, | zmm registers (the |
| that do not include the | (FIG. 8A; | 825, 830 | vector length is 64 byte) |
| vector length field | U = 0) | | |
| 859B | B | 812 | zmm registers (the |
| | (FIG. 8B; | | vector length is 64 byte) |
| | U = 1) | | |
| Instruction templates | B | 817, 827 | zmm, ymm, or xmm |
| that do include the | (FIG. 8B; | | registers (the vector |
| vector length field | U = 1) | | length is 64 byte, 32 |
| 859B | | | byte, or 16 byte) |
| | | | depending on the vector |
| | | | length field 859B |

In other words, the vector length field 859B selects between a maximum length and one or more other shorter lengths, where each such shorter length is half the length of the preceding length; and instructions templates without the vector length field 859B operate on the maximum vector length. Further, in one example, the class B instruction templates of the specific vector friendly instruction format 900 operate on packed or scalar single/double-precision floating point data and packed or scalar integer data. Scalar operations are operations performed on the lowest order data element position in a zmm/ymm/xmm register; the higher order data element positions are either left the same as they were prior to the instruction or zeroed depending on the example.

Write mask registers 1015—in the example illustrated, there are 8 write mask registers (k0 through k7), each 64 bits in size. In an alternate example, the write mask registers 1015 are 16 bits in size. As previously described, in one example of the disclosure, the vector mask register k0 cannot be used as a write mask; when the encoding that would normally indicate k0 is used for a write mask, it selects a hardwired write mask of 0xFFFF, effectively disabling write masking for that instruction.

General-purpose registers 1025—in the example illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1045, on which is aliased the MMX packed integer flat register file 1050—in the example illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative examples of the disclosure may use wider or narrower registers. Additionally, alternative examples of the disclosure may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

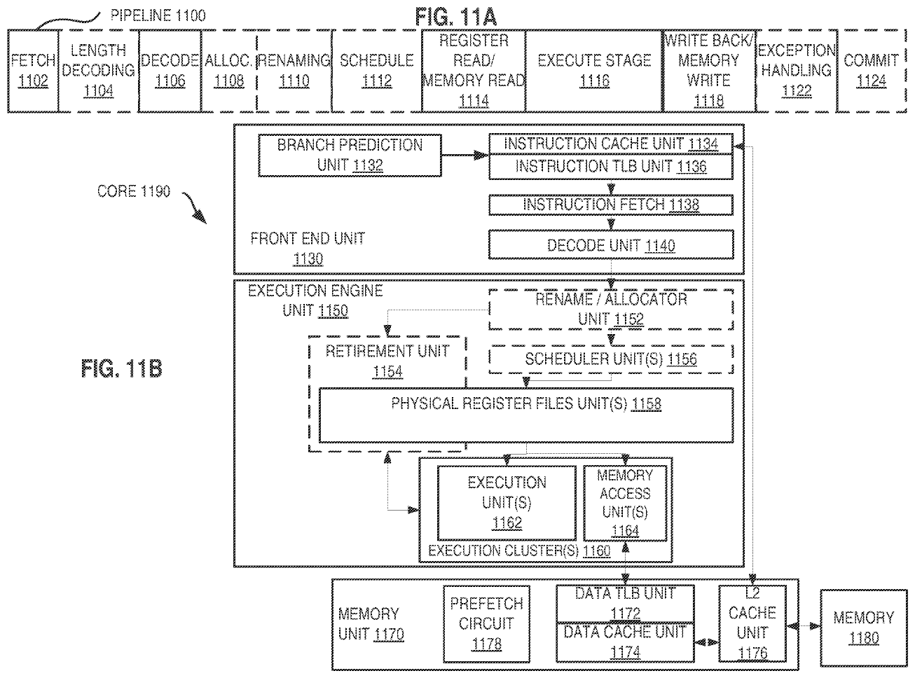

FIG. 11A is a block diagram illustrating both an exemplary in-order pipeline and an exemplary register renaming, out-of-order issue/execution pipeline according to examples of the disclosure. FIG. 11B is a block diagram illustrating both an exemplary example of an in-order architecture core and an exemplary register renaming, out-of-order issue/execution architecture core to be included in a processor according to examples of the disclosure. The solid lined boxes in FIGS. 11A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11A, a processor pipeline 1100 includes a fetch stage 1102, a length decode stage 1104, a decode stage 1106, an allocation stage 1108, a renaming stage 1110, a scheduling (also known as a dispatch or issue) stage 1112, a register read/memory read stage 1114, an execute stage 1116, a write back/memory write stage 1118, an exception handling stage 1122, and a commit stage 1124.

FIG. 11B shows processor core 1190 including a front end unit 1130 coupled to an execution engine unit 1150, and both are coupled to a memory unit 1170. The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front end unit 1130 includes a branch prediction unit 1132 coupled to an instruction cache unit 1134, which is coupled to an instruction translation lookaside buffer (TLB) 1136, which is coupled to an instruction fetch unit 1138, which is coupled to a decode unit 1140. The decode unit 1140 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 1140 may be implemented using various different mechanisms. Examples of suitable mechanisms include, but are not limited to, look-up tables, hardware implementations, programmable logic arrays (PLAs), microcode read only memories (ROMs), etc. In one example, the core 1190 includes a microcode ROM or other medium that stores microcode for certain macro-instructions (e.g., in decode unit 1140 or otherwise within the front end unit 1130). The decode unit 1140 is coupled to a rename/allocator unit 1152 in the execution engine unit 1150.

The execution engine unit 1150 includes the rename/allocator unit 1152 coupled to a retirement unit 1154 and a set of one or more scheduler unit(s) 1156. The scheduler unit(s) 1156 represents any number of different schedulers, including reservations stations, central instruction window, etc. The scheduler unit(s) 1156 is coupled to the physical register file(s) unit(s) 1158. Each of the physical register file(s) units 1158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one example, the physical register file(s) unit 1158 comprises a vector registers unit, a write mask registers unit, and a scalar registers unit. These register units may provide architectural vector registers, vector mask registers, and general purpose registers. The physical register file(s) unit(s) 1158 is overlapped by the retirement unit 1154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1154 and the physical register file(s) unit(s) 1158 are coupled to the execution cluster(s) 1160. The execution cluster(s) 1160 includes a set of one or more execution units 1162 and a set of one or more memory access units 1164. The execution units 1162 may perform various operations (e.g., shifts, addition, subtraction, multiplication) and on various types of data (e.g., scalar floating point, packed integer, packed floating point, vector integer, vector floating point). While some examples may include a number of execution units dedicated to specific functions or sets of functions, other examples may include only one execution unit or multiple execution units that all perform all functions. The scheduler unit(s) 1156, physical register file(s) unit(s) 1158, and execution cluster(s) 1160 are shown as being possibly plural because certain examples create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain examples are implemented in which only the execution cluster of this pipeline has the memory access unit(s) 1164). It should also be understood that where separate pipelines are used, one or more of these pipelines may be out-of-order issue/execution and the rest in-order.

The set of memory access units 1164 is coupled to the memory unit 1170, which includes a data TLB unit 1172 coupled to a data cache unit 1174 coupled to a level 2 (L2) cache unit 1176. In one exemplary example, the memory access units 1164 may include a load unit, a store address unit, and a store data unit, each of which is coupled to the data TLB unit 1172 in the memory unit 1170. The instruction cache unit 1134 is further coupled to a level 2 (L2) cache unit 1176 in the memory unit 1170. The L2 cache unit 1176 is coupled to one or more other levels of cache and eventually to a main memory.

In certain examples, a prefetch circuit 1178 is included to prefetch data, for example, to predict access addresses and bring the data for those addresses into a cache or caches (e.g., from memory 1180).

By way of example, the exemplary register renaming, out-of-order issue/execution core architecture may implement the pipeline 1100 as follows: 1) the instruction fetch 1138 performs the fetch and length decoding stages 1102 and 1104; 2) the decode unit 1140 performs the decode stage 1106; 3) the rename/allocator unit 1152 performs the allocation stage 1108 and renaming stage 1110; 4) the scheduler unit(s) 1156 performs the schedule stage 1112; 5) the physical register file(s) unit(s) 1158 and the memory unit 1170 perform the register read/memory read stage 1114; the execution cluster 1160 perform the execute stage 1116; 6) the memory unit 1170 and the physical register file(s) unit(s) 1158 perform the write back/memory write stage 1118; 7) various units may be involved in the exception handling stage 1122; and 8) the retirement unit 1154 and the physical register file(s) unit(s) 1158 perform the commit stage 1124.

The core 1190 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one example, the core 1190 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyper-Threading technology).

While register renaming is described in the context of out-of-order execution, it should be understood that register renaming may be used in an in-order architecture. While the illustrated example of the processor also includes separate instruction and data cache units 1134/1174 and a shared L2 cache unit 1176, alternative examples may have a single internal cache for both instructions and data, such as, for example, a Level 1 (L1) internal cache, or multiple levels of internal cache. In some examples, the system may include a combination of an internal cache and an external cache that is external to the core and/or the processor. Alternatively, all of the cache may be external to the core and/or the processor.

### Specific Exemplary In-Order Core Architecture

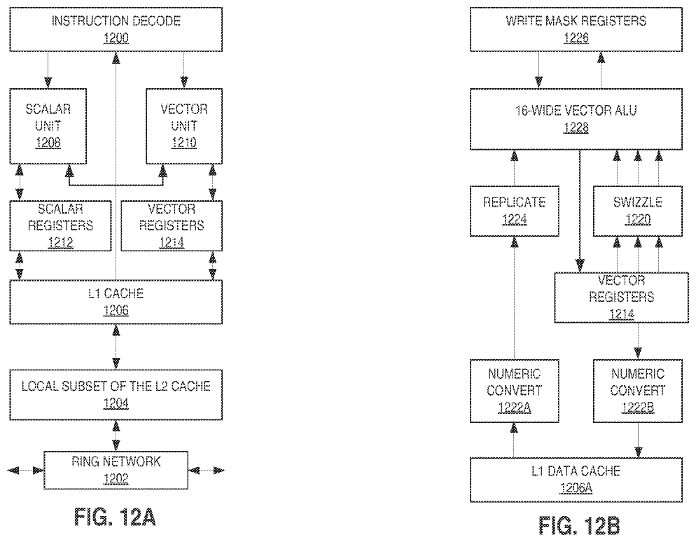

FIGS. 12A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 12A is a block diagram of a single processor core, along with its connection to the on-die interconnect network 1202 and with its local subset of the Level 2 (L2) cache 1204, according to examples of the disclosure. In one example, an instruction decode unit 1200 supports the x86 instruction set with a packed data instruction set extension. An L1 cache 1206 allows low-latency accesses to cache memory into the scalar and vector units. While in one example (to simplify the design), a scalar unit 1208 and a vector unit 1210 use separate register sets (respectively, scalar registers 1212 and vector registers 1214) and data transferred between them is written to memory and then read back in from a level 1 (L1) cache 1206, alternative examples of the disclosure may use a different approach (e.g., use a single register set or include a communication path that allow data to be transferred between the two register files without being written and read back).

The local subset of the L2 cache 1204 is part of a global L2 cache that is divided into separate local subsets, one per processor core. Each processor core has a direct access path to its own local subset of the L2 cache 1204. Data read by a processor core is stored in its L2 cache subset 1204 and can be accessed quickly, in parallel with other processor cores accessing their own local L2 cache subsets. Data written by a processor core is stored in its own L2 cache subset 1204 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 12B is an expanded view of part of the processor core in FIG. 12A according to examples of the disclosure. FIG. 12B includes an L1 data cache 1206A part of the L1 cache 1204, as well as more detail regarding the vector unit 1210 and the vector registers 1214. Specifically, the vector unit 1210 is a 16-wide vector processing unit (VPU) (see the 16-wide ALU 1228), which executes one or more of integer, single-precision float, and double-precision float instructions. The VPU supports swizzling the register inputs with swizzle unit 1220, numeric conversion with numeric convert units 1222A-B, and replication with replication unit 1224 on the memory input. Write mask registers 1226 allow predicating resulting vector writes.

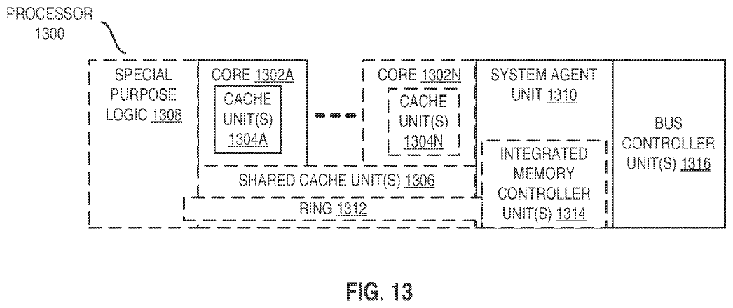

FIG. 13 is a block diagram of a processor 1300 that may have more than one core, may have an integrated memory controller, and may have integrated graphics according to examples of the disclosure. The solid lined boxes in FIG. 13 illustrate a processor 1300 with a single core 1302A, a system agent 1310, a set of one or more bus controller units 1316, while the optional addition of the dashed lined boxes illustrates an alternative processor 1300 with multiple cores 1302A-N, a set of one or more integrated memory controller unit(s) 1314 in the system agent unit 1310, and special purpose logic 1308.

Thus, different implementations of the processor 1300 may include: 1) a CPU with the special purpose logic 1308 being integrated graphics and/or scientific (throughput) logic (which may include one or more cores), and the cores 1302A-N being one or more general purpose cores (e.g., general purpose in-order cores, general purpose out-of-order cores, a combination of the two); 2) a coprocessor with the cores 1302A-N being a large number of special purpose cores intended primarily for graphics and/or scientific (throughput); and 3) a coprocessor with the cores 1302A-N being a large number of general purpose in-order cores. Thus, the processor 1300 may be a general-purpose processor, coprocessor, or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, BiCMOS, CMOS, or NMOS.

The memory hierarchy includes one or more levels of cache 1304A-1304N within the cores, a set or one or more shared cache units 1306, and external memory (not shown) coupled to the set of integrated memory controller units 1314. The set of shared cache units 1306 may include one or more mid-level caches, such as level 2 (L2), level 3 (L3), level 4 (L4), or other levels of cache, a last level cache (LLC), and/or combinations thereof. While in one example a ring based interconnect unit 1312 interconnects the integrated graphics logic 1308, the set of shared cache units 1306, and the system agent unit 1310/integrated memory controller unit(s) 1314, alternative examples may use any number of well-known techniques for interconnecting such units. In one example, coherency is maintained between one or more cache units 1306 and cores 1302-A-N.

In some examples, one or more of the cores 1302A-N are capable of multithreading. The system agent 1310 includes those components coordinating and operating cores 1302A-N. The system agent unit 1310 may include for example a power control unit (PCU) and a display unit. The PCU may be or include logic and components needed for regulating the power state of the cores 1302A-N and the integrated graphics logic 1308. The display unit is for driving one or more externally connected displays.

The cores 1302A-N may be homogenous or heterogeneous in terms of architecture instruction set; that is, two or more of the cores 1302A-N may be capable of execution the same instruction set, while others may be capable of executing only a subset of that instruction set or a different instruction set.

### Exemplary Computer Architectures

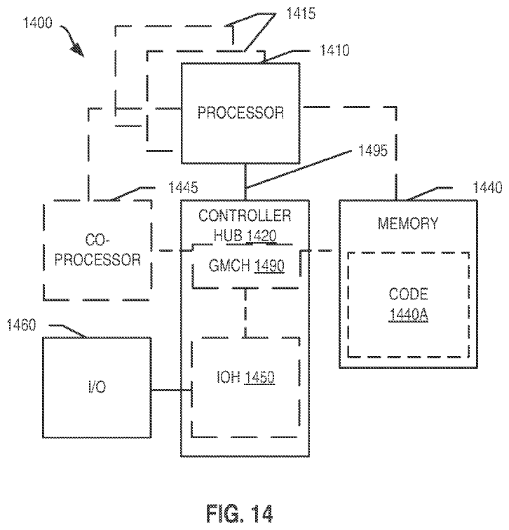

FIGS. 14-17 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

Referring now to FIG. 14, shown is a block diagram of a system 1400 in accordance with one example of the present disclosure. The system 1400 may include one or more processors 1410, 1415, which are coupled to a controller hub 1420. In one example the controller hub 1420 includes a graphics memory controller hub (GMCH) 1490 and an Input/Output Hub (IOH) 1450 (which may be on separate chips); the GMCH 1490 includes memory and graphics controllers to which are coupled memory 1440 and a coprocessor 1445; the IOH 1450 is couples input/output (I/O) devices 1460 to the GMCH 1490. Alternatively, one or both of the memory and graphics controllers are integrated within the processor (as described herein), the memory 1440 and the coprocessor 1445 are coupled directly to the processor 1410, and the controller hub 1420 in a single chip with the IOH 1450. Memory 1440 may include code 1440A, for example, that when executed causes a processor to perform any method of this disclosure.

The optional nature of additional processors 1415 is denoted in FIG. 14 with broken lines. Each processor 1410, 1415 may include one or more of the processing cores described herein and may be some version of the processor 1300.

The memory 1440 may be, for example, dynamic random access memory (DRAM), phase change memory (PCM), or a combination of the two. For at least one example, the controller hub 1420 communicates with the processor(s) 1410, 1415 via a multi-drop bus, such as a frontside bus (FSB), point-to-point interface such as Quickpath Interconnect (QPI), or similar connection 1495.

In one example, the coprocessor 1445 is a special-purpose processor, such as, for example, a high-throughput MIC processor, a network or communication processor, compression engine, graphics processor, GPGPU, embedded processor, or the like. In one example, controller hub 1420 may include an integrated graphics accelerator.

There can be a variety of differences between the physical resources 1410, 1415 in terms of a spectrum of metrics of merit including architectural, microarchitectural, thermal, power consumption characteristics, and the like.

In one example, the processor 1410 executes instructions that control data processing operations of a general type. Embedded within the instructions may be coprocessor instructions. The processor 1410 recognizes these coprocessor instructions as being of a type that should be executed by the attached coprocessor 1445. Accordingly, the processor 1410 issues these coprocessor instructions (or control signals representing coprocessor instructions) on a coprocessor bus or other interconnect, to coprocessor 1445. Coprocessor(s) 1445 accept and execute the received coprocessor instructions.

Referring now to FIG. 15, shown is a block diagram of a first more specific exemplary system 1500 in accordance with an example of the present disclosure. As shown in FIG. 15, multiprocessor system 1500 is a point-to-point interconnect system, and includes a first processor 1570 and a second processor 1580 coupled via a point-to-point interconnect 1550. Each of processors 1570 and 1580 may be some version of the processor 1300. In one example of the disclosure, processors 1570 and 1580 are respectively processors 1410 and 1415, while coprocessor 1538 is coprocessor 1445. In another example, processors 1570 and 1580 are respectively processor 1410 coprocessor 1445.

Processors 1570 and 1580 are shown including integrated memory controller (IMC) units 1572 and 1582, respectively. Processor 1570 also includes as part of its bus controller units point-to-point (P-P) interfaces 1576 and 1578; similarly, second processor 1580 includes P-P interfaces 1586 and 1588. Processors 1570, 1580 may exchange information via a point-to-point (P-P) interface 1550 using P-P interface circuits 1578, 1588. As shown in FIG. 15, IMCs 1572 and 1582 couple the processors to respective memories, namely a memory 1532 and a memory 1534, which may be portions of main memory locally attached to the respective processors.

Processors 1570, 1580 may each exchange information with a chipset 1590 via individual P-P interfaces 1552, 1554 using point to point interface circuits 1576, 1594, 1586, 1598. Chipset 1590 may optionally exchange information with the coprocessor 1538 via a high-performance interface 1539. In one example, the coprocessor 1538 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1590 may be coupled to a first bus 1516 via an interface 1596. In one example, first bus 1516 may be a Peripheral Component Interconnect (PCI) bus, or a bus such as a PCI Express bus or another third generation I/O interconnect bus, although the scope of the present disclosure is not so limited.

As shown in FIG. 15, various I/O devices 1514 may be coupled to first bus 1516, along with a bus bridge 1518 which couples first bus 1516 to a second bus 1520. In one example, one or more additional processor(s) 1515, such as coprocessors, high-throughput MIC processors, GPGPU's, accelerators (such as, e.g., graphics accelerators or digital signal processing (DSP) units), field programmable gate arrays, or any other processor, are coupled to first bus 1516. In one example, second bus 1520 may be a low pin count (LPC) bus. Various devices may be coupled to a second bus 1520 including, for example, a keyboard and/or mouse 1522, communication devices 1527 and a storage unit 1528 such as a disk drive or other mass storage device which may include instructions/code and data 1530, in one example. Further, an audio I/O 1524 may be coupled to the second bus 1520. Note that other architectures are possible. For example, instead of the point-to-point architecture of FIG. 15, a system may implement a multi-drop bus or other such architecture.

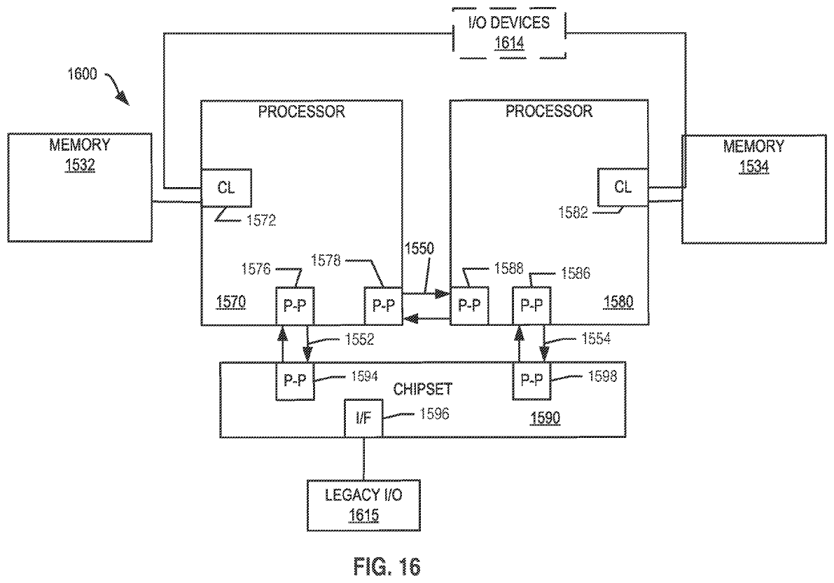

Referring now to FIG. 16, shown is a block diagram of a second more specific exemplary system 1600 in accordance with an example of the present disclosure. Like elements in FIGS. 15 and 16 bear like reference numerals, and certain aspects of FIG. 15 have been omitted from FIG. 16 in order to avoid obscuring other aspects of FIG. 16.

FIG. 16 illustrates that the processors 1570, 1580 may include integrated memory and I/O control logic (“CL”) 1572 and 1582, respectively. Thus, the CL 1572, 1582 include integrated memory controller units and include I/O control logic. FIG. 16 illustrates that not only are the memories 1532, 1534 coupled to the CL 1572, 1582, but also that I/O devices 1614 are also coupled to the control logic 1572, 1582. Legacy I/O devices 1615 are coupled to the chipset 1590.

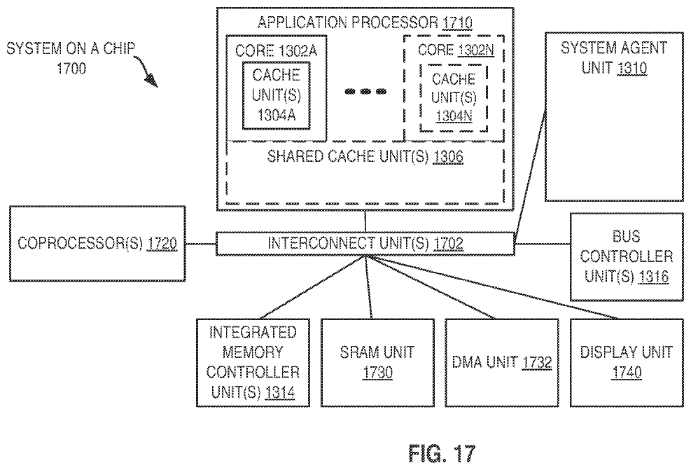

Referring now to FIG. 17, shown is a block diagram of a SoC 1700 in accordance with an example of the present disclosure. Similar elements in FIG. 13 bear like reference numerals. Also, dashed lined boxes are optional features on more advanced SoCs. In FIG. 17, an interconnect unit(s) 1702 is coupled to: an application processor 1710 which includes a set of one or more cores 1302A-N and shared cache unit(s) 1306; a system agent unit 1310; a bus controller unit(s) 1316; an integrated memory controller unit(s) 1314; a set or one or more coprocessors 1720 which may include integrated graphics logic, an image processor, an audio processor, and a video processor; an static random access memory (SRAM) unit 1730; a direct memory access (DMA) unit 1732; and a display unit 1740 for coupling to one or more external displays. In one example, the coprocessor(s) 1720 include a special-purpose processor, such as, for example, a network or communication processor, compression engine, GPGPU, a high-throughput MIC processor, embedded processor, or the like.

Examples (e.g., of the mechanisms) disclosed herein may be implemented in hardware, software, firmware, or a combination of such implementation approaches. Examples of the disclosure may be implemented as computer programs or program code executing on programmable systems comprising at least one processor, a storage system (including volatile and non-volatile memory and/or storage elements), at least one input device, and at least one output device.

Program code, such as code 1530 illustrated in FIG. 15, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples of the disclosure also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

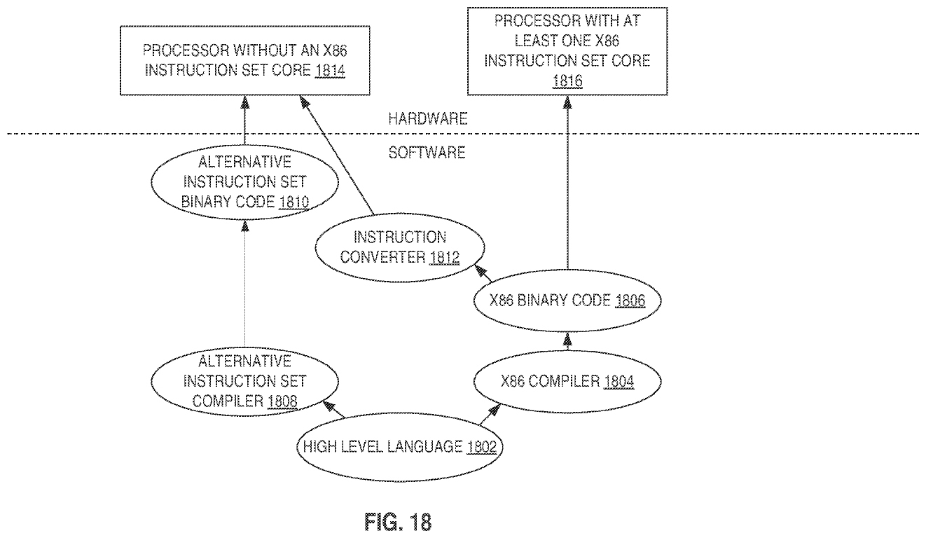

FIG. 18 is a block diagram contrasting the use of a software instruction converter to convert binary instructions in a source instruction set to binary instructions in a target instruction set according to examples of the disclosure. In the illustrated example, the instruction converter is a software instruction converter, although alternatively the instruction converter may be implemented in software, firmware, hardware, or various combinations thereof. FIG. 18 shows a program in a high level language 1802 may be compiled using an x86 compiler 1804 to generate x86 binary code 1806 that may be natively executed by a processor with at least one x86 instruction set core 1816. The processor with at least one x86 instruction set core 1816 represents any processor that can perform substantially the same functions as an Intel® processor with at least one x86 instruction set core by compatibly executing or otherwise processing (1) a substantial portion of the instruction set of the Intel® x86 instruction set core or (2) object code versions of applications or other software targeted to run on an Intel® processor with at least one x86 instruction set core, in order to achieve substantially the same result as an Intel® processor with at least one x86 instruction set core. The x86 compiler 1804 represents a compiler that is operable to generate x86 binary code 1806 (e.g., object code) that can, with or without additional linkage processing, be executed on the processor with at least one x86 instruction set core 1816. Similarly, FIG. 18 shows the program in the high level language 1802 may be compiled using an alternative instruction set compiler 1808 to generate alternative instruction set binary code 1810 that may be natively executed by a processor without at least one x86 instruction set core 1814 (e.g., a processor with cores that execute the MIPS instruction set of MIPS Technologies of Sunnyvale, CA and/or that execute the ARM instruction set of ARM Holdings of Sunnyvale, CA). The instruction converter 1812 is used to convert the x86 binary code 1806 into code that may be natively executed by the processor without an x86 instruction set core 1814. This converted code is not likely to be the same as the alternative instruction set binary code 1810 because an instruction converter capable of this is difficult to make; however, the converted code will accomplish the general operation and be made up of instructions from the alternative instruction set. Thus, the instruction converter 1812 represents software, firmware, hardware, or a combination thereof that, through emulation, simulation, or any other process, allows a processor or other electronic device that does not have an x86 instruction set processor or core to execute the x86 binary code 1806.

1. An apparatus comprising:
a hardware processor core comprising a trust domain manager to manage one or more hardware isolated virtual machines as a respective trust domain;
a coupling between the hardware processor core and an input/output device; and
a secure startup service circuit separate from the trust domain manager to, in response to a request from the trust domain manager, generate a secure communication session between the trust domain manager and the input/output device.

2. The apparatus of claim 1, wherein the secure startup service circuit is to generate the secure communication session between the trust domain manager and the input/output device without stalling the trust domain manager of the hardware processor core until the generation of the secure communication session is complete.

3. The apparatus of claim 1, wherein the secure communication session is according to a Security Protocol and Data Model (SPDM) standard.

4. The apparatus of claim 3, wherein the secure communication session is also according to a Device Interface Management Protocol (DIMP) standard.

5. The apparatus of claim 1, wherein the secure startup service circuit is to communicate with the input/output device to setup the secure communication session comprising a device certificate, and send the device certificate for the input/output device to the trust domain manager of the hardware processor core to generate the secure communication session between the trust domain manager and the input/output device.

6. The apparatus of claim 1, wherein the secure startup service circuit is to communicate with the input/output device to setup the secure communication session comprising a session key, and send the session key to the trust domain manager of the hardware processor core to generate the secure communication session between the trust domain manager and the input/output device.

7. The apparatus of claim 1, wherein the secure startup service circuit is to communicate with the input/output device to setup the secure communication session comprising a session key and a device certificate, and send the session key and the device certificate for the input/output device to the trust domain manager of the hardware processor core to generate the secure communication session between the trust domain manager and the input/output device.

8. The apparatus of claim 1, wherein the request from the trust domain manager is caused by a request from a hardware isolated virtual machine, as a trust domain, to access the input/output device by the secure communication session.

9. A method comprising:
managing one or more hardware isolated virtual machines as a respective trust domain by a trust domain manager of a hardware processor core;
generating, by a secure startup service circuit separate from the trust domain manager, a secure communication session between the trust domain manager and an input/output device in response to a request from the trust domain manager; and
communicating between the trust domain manager and the input/output device on the secure communication session.

10. The method of claim 9, wherein the generating the secure communication session between the trust domain manager and the input/output device is without stalling the trust domain manager of the hardware processor core until the generation of the secure communication session is complete.

11. The method of claim 9, wherein the secure communication session is according to a Security Protocol and Data Model (SPDM) standard.

12. The method of claim 11, wherein the secure communication session is also according to a Device Interface Management Protocol (DIMP) standard.

13. The method of claim 9, wherein the generating comprises:
communicating by the secure startup service circuit with the input/output device to setup the secure communication session comprising a device certificate; and
sending the device certificate for the input/output device to the trust domain manager of the hardware processor core to generate the secure communication session between the trust domain manager and the input/output device.

14. The method of claim 9, wherein the generating comprises:
communicating by the secure startup service circuit with the input/output device to setup the secure communication session comprising a session key; and
sending the session key to the trust domain manager of the hardware processor core to generate the secure communication session between the trust domain manager and the input/output device.

15. The method of claim 9, wherein the generating comprises:
communicating by the secure startup service circuit with the input/output device to setup the secure communication session comprising a session key and a device certificate; and
sending the session key and the device certificate for the input/output device to the trust domain manager of the hardware processor core to generate the secure communication session between the trust domain manager and the input/output device.

16. The method of claim 9, further comprising sending a request from a hardware isolated virtual machine, as a trust domain, to access the input/output device by the secure communication session, wherein the request from the hardware isolated virtual machine causes the request to be sent from the trust domain manager to the secure startup service circuit.

17. A system comprising:
a hardware processor core comprising a trust domain manager to manage one or more hardware isolated virtual machines as a respective trust domain;
an input/output device coupled to the hardware processor core; and
a secure startup service circuit separate from the trust domain manager to, in response to a request from the trust domain manager, generate a secure communication session between the trust domain manager and the input/output device.

18. The system of claim 17, wherein the secure startup service circuit is to generate the secure communication session between the trust domain manager and the input/output device without stalling the trust domain manager of the hardware processor core until the generation of the secure communication session is complete.

19. The system of claim 17, wherein the secure communication session is according to a Security Protocol and Data Model (SPDM) standard.

20. The system of claim 19, wherein the secure communication session is also according to a Device Interface Management Protocol (DIMP) standard.

21.-24. (canceled)
